(19) United States
(12) Patent Application Publication
(10) Pub. No.: US 2012/0176947 A1
(43) Pub. Date: Jul. 12, 2012

(54) METHOD AND APPARATUS FOR SENDING FEEDBACK FOR MULTI-CELL HIGH SPEED DOWNLINK PACKET ACCESS OPERATIONS

(75) Inventors: Fengjun Xi, Huntington Station, NY (US); Lujing Cai, Morganville, NJ (US); Joseph S. Levy, Merrick, NY (US); Janet A. Stern-Berkowitz, Little Neck, NY (US)

(73) Assignee: INTERDIGITAL PATENT HOLDINGS, INC., Wilmington, DE (US)

(21) Appl. No.: 13/345,598

(22) Filed: Jan. 6, 2012

Related U.S. Application Data
(60) Provisional application No. 61/430,905, filed on Jan. 7, 2011.
(60) Provisional application No. 61/442,052, filed on Feb. 11, 2011.
(60) Provisional application No. 61/480,859, filed on Apr. 29, 2011.
(60) Provisional application No. 61/522,356, filed on Aug. 11, 2011.

(51) Int. Cl. H04W 72/04; H04W 52/02

(52) U.S. Cl. 370/311; 370/329

(57) ABSTRACT

A method and apparatus for sending feedback for multi-cell high speed downlink packet access (HSDPA) operations are disclosed. A wireless transmit/receive unit (WTRU) may generate and send hybrid automatic repeat request acknowledgement (HARQ-ACK) messages and/or channel quality indication (CQI) or precoding control indication/channel quality indication (PCI/CQI) messages for a plurality of cells via a plurality of high speed dedicated physical control channels (HS-DPCCHs) with a spreading factor of 128. Each HARQ-ACK message may be mapped to two cells and each CQI or PCI/CQI message may be mapped to one cell. The cells may be remapped to an HARQ-ACK message and a CQI or PCI/CQI message within an HS-DPCCH on a condition that any cell is activated or deactivated on that HS-DPCCH.

### CROSS REFERENCE TO RELATED APPLICATIONS

This application claims the benefit of U.S. provisional application Nos. 61/430,905 filed Jan. 7, 2011, 61/442,052 filed Feb. 11, 2011, 61/480,859 filed Apr. 29, 2011, and 61/522,356 filed Aug. 11, 2011, the contents of which are hereby incorporated by reference herein.

### BACKGROUND

Wireless technologies continue to evolve to meet the increasing demand in bandwidth from end users. Recently, as part of the Release 8 of the Third Generation Partnership Project (3GPP) wideband code division multiple access (WCDMA) specifications, a new feature allowing simultaneous use of two high speed downlink packet access (HSDPA) downlink carriers has been introduced. This new feature improves the bandwidth usage via frequency diversity and resource pooling. This feature was extended to include the multiple-input multiple-output (MIMO) function in Release 9 and to four carrier operations in 3GPP Release 10. For 3GPP Release 11, eight-carrier HSDPA (8C-HSDPA) has been introduced, which allows up to 8 carriers to operate simultaneously to achieve a higher downlink throughput.

The hybrid automatic repeat request (HARQ) acknowledgement (HARQ-ACK), and the channel quality indication (CQI) (or a precoding control indication/channel quality indication (PCI/CQI)) to indicate the downlink channel conditions are transmitted to the network over a high speed dedicated physical control channel (HS-DPCCH) in the uplink. The structure of the HS-DPCCH is designed to accommodate the need for sending the feedback information via one uplink for all downlink carriers.

The introduction of 8 carrier operation poses a challenge to uplink feedback. If the network is transmitting in more than four carriers simultaneously, a wireless transmit/receive unit (WTRU) needs to be capable of acknowledging the data reception for all carriers, and all the data streams if MIMO is configured. Since the MIMO operation may be configured on each downlink carrier independently, the HS-DPCCH feedback design should be performed for all possible downlink configurations. Where up to 8 carriers are allowed to be configured with MIMO, the number of combinations of the positive acknowledgement (ACK), negative acknowledgement (NACK), and discontinuous transmission (DTX) states would be 7⁸−4=5,764,800 states. The CQI reporting information is also doubled as compared to 4 carrier operation.

### SUMMARY

A wireless transmit/receive unit (WTRU) may generate and send HARQ-ACK messages and/or CQI or PCI/CQI messages for a plurality of cells via a plurality of HS-DPCCHs with a spreading factor of 128. Each HARQ-ACK message may be mapped to two cells and each CQI or PCI/CQI message may be mapped to one cell. The cells may be remapped to an HARQ-ACK message and a CQI or PCI/CQI message within an HS-DPCCH on a condition that any cell is activated or deactivated on that HS-DPCCH. A power offset for the HARQ-ACK message or the CQI or PCI/CQI message on each HS-DPCCH may be determined independently based on a number of active cells and the MIMO configuration status on each HS-DPCCH. An HARQ preamble and/or an HARQ postamble may be transmitted simultaneously on both HS-DPCCHs on a condition that a condition for transmitting the preamble and/or postamble is satisfied on both HS-DPCCHs.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIGS. 2-4 show example feedback message formats for an HS-DPCCH with a spreading factor (SF) of 64;

FIG. 5 shows an example message format for HS-DPCCHs with an SF of 128;

FIG. 6 shows an example physical channel mapping for HARQ-ACK messages to one HS-DPCCH with SF=64 in accordance with one embodiment;

FIG. 7 shows an example physical channel mapping for CQI (or PCI/CQI) messages to one HS-DPCCH with SF=64 in accordance with one embodiment;

FIG. 8 shows an example physical channel mapping for HARQ-ACK messages to two HS-DPCCHs with SF=128 in accordance with one embodiment;

FIG. 9 shows an example physical channel mapping for CQI (or PCI/CQI) messages to two HS-DPCCHs with SF=128 in accordance with one embodiment;

FIG. 10 shows an example carrier association for one HS-DPCCH with SF=64, where the CQI reports are transmitted over two sub-frames;

FIG. 11 shows an example carrier association for two HS-DPCCHs with SF=128, where the CQI reports are transmitted over two sub-frames;

FIG. 12 shows an example message layout format for one HS-DPCCH with SF of 128 for six cells (6C) without MIMO;

FIG. 13 shows an example message layout format for one HS-DPCCH with SF of 128 for three cells (3C) without MIMO;

FIG. 14 shows an example per-channel carrier association upon activation/deactivation for two HS-DPCCHs with SF=128;

FIG. 15 shows an example cross-channel carrier association upon activation/deactivation for two HS-DPCCHs with SF=128; and

FIG. 16 shows an example HS-DPCCH frame format with SF=128 for 8C-HSDPA 8C/7C special cases.

### DETAILED DESCRIPTION

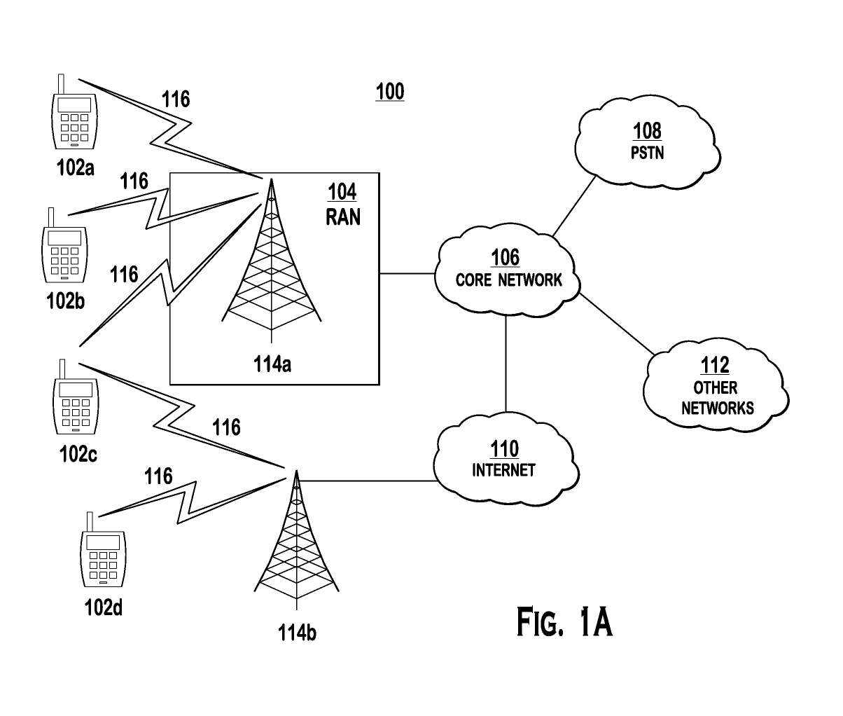

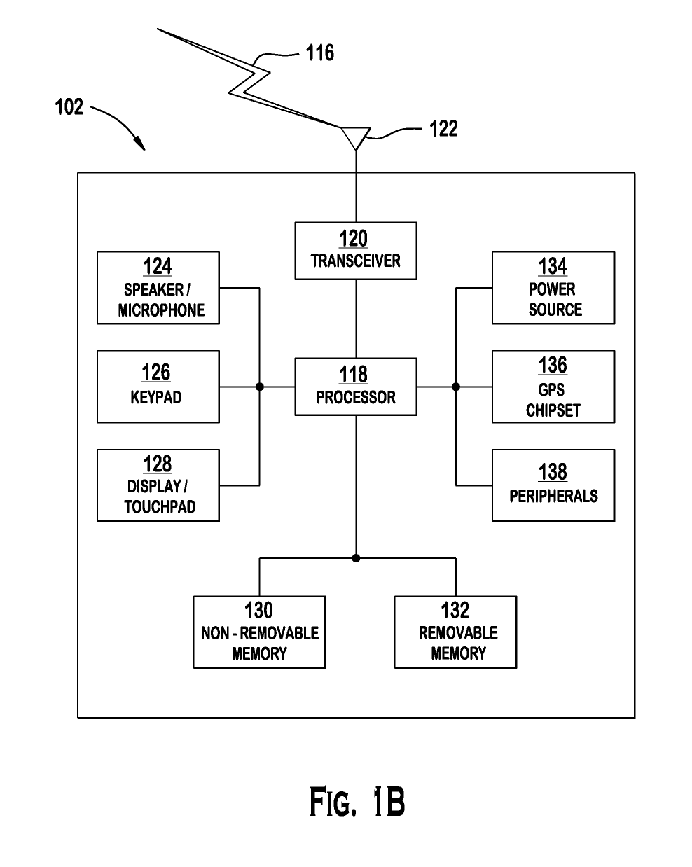

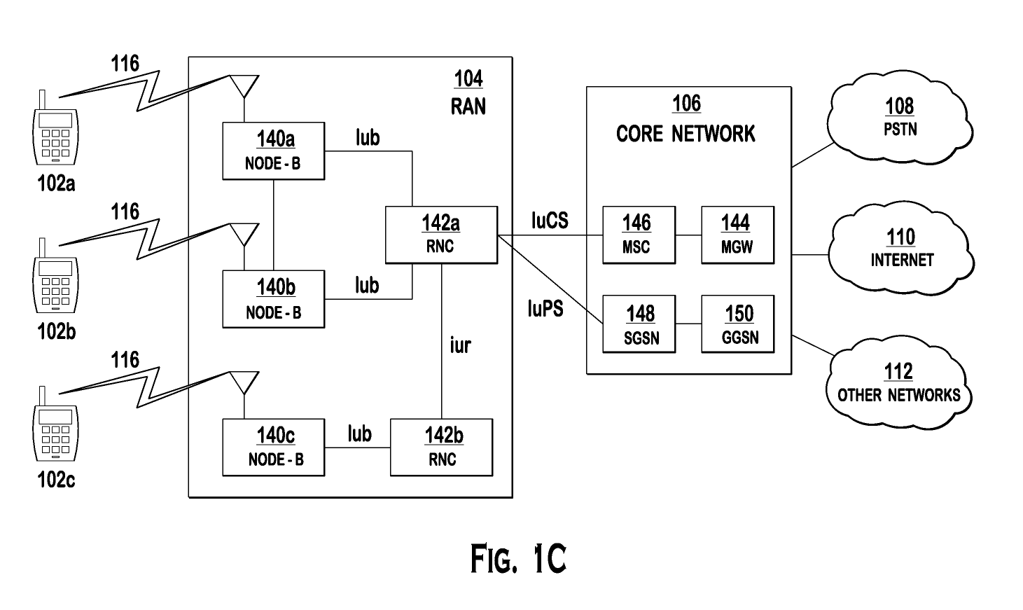

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ a UTRA radio technology to communicate with the WTRUs 102a, 102b, 102c over the air interface 116. The RAN 104 may also be in communication with the core network 106. As shown in FIG. 1C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to other networks 112, which may include other wired or wireless networks that are owned and/or operated by other service providers.

Hereafter, the terms “PCI/CQI” and “CQI” may be used interchangeably, depending on the context, and the terms “cell,” “HS-DSCH cell,” “frequency,” and “carrier” will be used interchangeably. The HS-DSCH cell may be a serving HS-DSCH cell or a secondary serving HS-DSCH cell. The terms “primary serving cell” and “serving HS-DSCH cell” will be used interchangeably, and the terms “secondary serving cell” and “secondary serving HS-DSCH cell” will be used interchangeably. The terms “HS-DPCCH1”, “HS-DPCCH” and “primary HS-DPCCH” may be used interchangeably. The terms “HS-DPCCH2”, “HS-DPCCH₂” and “secondary HS-DPCCH” may be used interchangeably. In MC-HSDPA, Secondary_Cell_Enabled is equal to the number of the configured secondary serving HS-DSCH cells. When it is stated that “Secondary_Cell_Enabled is greater than 3,” it may mean 8C-HSDPA.

The embodiments below will be explained with reference to a case where a single uplink is used for the feedback, and the HARQ-ACK and CQI (or PCI/CQI) messages are coded and transmitted independently in different time durations. However, it should be noted that the embodiments are also applicable to a case where dual or multiple uplinks are used, (e.g., multi-carrier high speed uplink packet access (HSUPA)). It should also be noted that the embodiments will be explained with reference to 8C-HSDPA, but the embodiments are applicable to multi-carrier operations with any number of downlink and uplink carriers. It should also be noted that the embodiments related to 2 HS-DPCCHs with SF of 128 for 8C-HSDPA may be applicable to other cases with 2 or more HS-DPCCHs configured.

An HS-DPCCH carries HARQ-ACK messages and CQI (or PCI/CQI in case of MIMO configured) messages. The HS-DPCCH frame structure, when a WTRU is configured for multiple downlink carrier operations, may be the same as the conventional HS-DPCCH frame structure. Each HS-DPCCH sub-frame of length 2 ms (3×2560 chips) comprises 3 slots, each of length 2,560 chips.

In one embodiment, a new HS-DPCCH slot format is defined with a spreading factor (SF) of 64, and one HS-DPCCH with an SF of 64 may be used for 8C-HSDPA. With the SF of 64, the number of available bits of the HS-DPCCH (assuming the HS-DPCCH uses the same binary phase shift keying (BPSK) modulation) is doubled per sub-frame as compared to the HS-DPCCH slot format with SF=128.

Table 1 shows different HS-DPCCH slot formats. Slot format #2 is the HS-DPCCH slot format with SF of 64. Slot format #2 carries 40 bits per slot, and a total of 120 bits are carried in the HS-DPCCH sub-frame. With slot format #2, one HS-DPCCH sub-frame may carry four 10-bit HARQ-ACK codewords and four 20-bit CQI (or PCI/CQI) messages. Slot format #1 carries 20 bits per slot, and a total of 60 bits are carried in the HS-DPCCH sub-frame. With slot format #1, one HS-DPCCH sub-frame may carry two 10-bit HARQ-ACK codewords and two 20-bit CQI (or PCI/CQI) messages.

TABLE 1

| Slot | Channel | Channel | | | | Transmitted |
|---|---|---|---|---|---|---|
| Format | Bit Rate | Symbol | | Bits/ | Bits/ | slots per |
| # | (kbps) | Rate (ksps) | SF | Subframe | Slot | Subframe |
| 0 | 15 | 15 | 256 | 30 | 10 | 3 |
| 1 | 30 | 30 | 128 | 60 | 20 | 3 |
| 2 | 60 | 60 | 64 | 120 | 40 | 3 |

If more than three secondary serving HS-DSCH cells are configured (i.e., Secondary_Cell_Enabled>3), the HS-DPCCH slot format #2 may be used. If Secondary_Cell_Enabled is 4, 5, 6, or 7 and MIMO is not configured in any cell, the HS-DPCCH slot format #1 may be used. Alternatively, the WTRU may use the HS-DPCCH slot format #1 whenever it is configured (by RRC) with more than three secondary serving HS-DSCH cells (i.e., Secondary_Cell_Enabled>3).

With some exceptions for special cases, the cells are paired and HARQ-ACK status, (i.e., either positive ACK or negative ACK), for a pair of cells are jointly encoded, and the CQI or PCI/CQI is independently encoded for each cell. For 8C-HSDPA, up to 4 jointly encoded HARQ-ACK messages and 8 CQI (or PCI/CQI) messages may be generated.

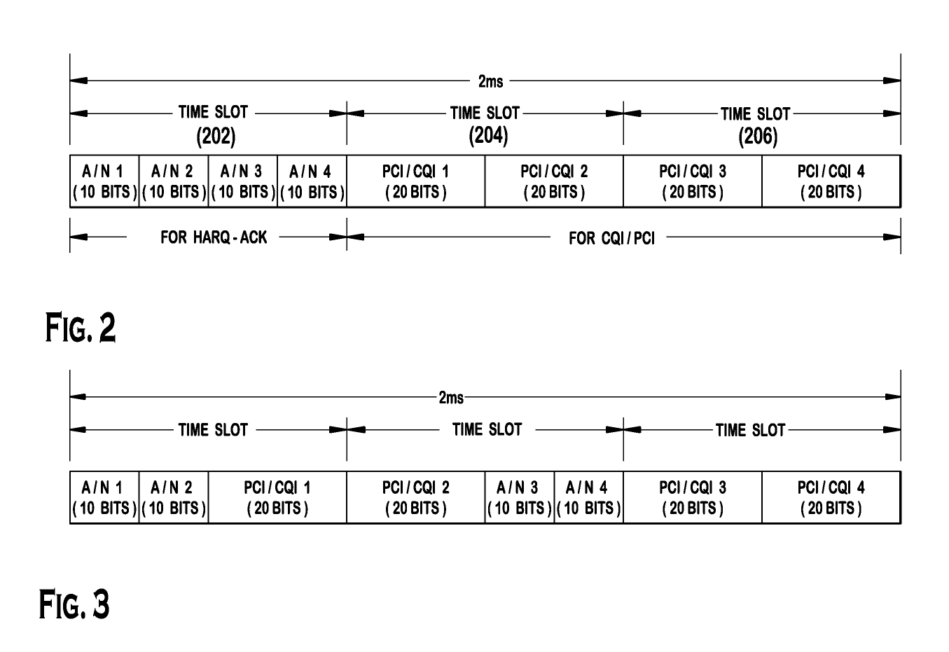

The HARQ-ACK messages and the CQI (or PCI/CQI) messages may be grouped separately and placed in different time sections in an HS-DPCCH sub-frame. FIG. 2 shows an example feedback message format in accordance with one embodiment. The first time slot 202 of the HS-DPCCH sub-frame may be assigned for the HARQ-ACK messages, which contains 4 encoded HARQ-ACK messages (i.e., codewords) concatenated in time, and the remaining two time slots 204, 206 in the HS-DPCCH sub-frame may be allocated to carry the encoded CQI (or PCI/CQI) messages. Four sets of HARQ-ACK messages and four sets of CQI (or PCI/CQI) messages are transmitted over an HS-DPCCH sub-frame. The HARQ-ACK messages and the CQI (or PCI/CQI) messages are concatenated in time (i.e., time division multiplexed in transmission).

Alternatively, each half of the sub-frame may include two HARQ-ACK messages and two CQI (or PCI/CQI) messages, as shown in FIG. 3. Alternatively, each set of the HARQ-ACK and CQI (or PCI/CQI) feedback messages may be arranged sequentially, as shown in FIG. 4.

In FIGS. 2-4, each set of the feedback messages comprises an HARQ-ACK message and a CQI (or PCI/CQI) message. For example, the first set of feedback message contains A/N1 of 10 bits and CQI1 (or PCI/CQI1) of 20 bits. It should be noted that the HARQ-ACK message and the CQI (or PCI/CQI) message may not necessarily be tied each other in the same set or to a particular carrier, and the numbering of the feedback message set may not necessarily indicate the association with a particular carrier throughout the embodiments below.

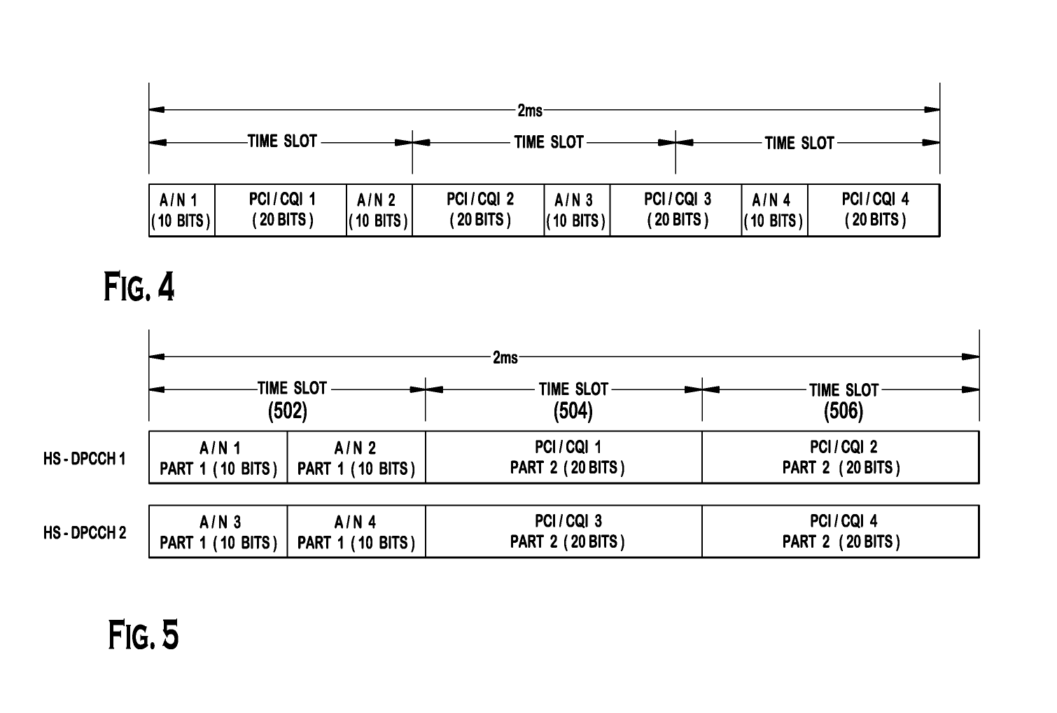

In another embodiment, two HS-DPCCH physical channel(s) with SF of 128 (i.e., slot format #1) may be used to support the uplink feedback for up to 8 carriers. The two HS-DPCCHs may use the same or different channelization codes in the same uplink carrier (e.g., the primary uplink frequency) if single or dual carrier uplink operation (i.e., SC-HSUPA or DC-HSUPA) is supported. Therefore, in MC-HSDPA, there may be one HS-DPCCH on each radio link if Secondary_Cell_Enabled<4 and two HS-DPCCHs otherwise. If two HS-DPCCHs are transmitted, they may have same timing. FIG. 5 shows an example message layout format for the HS-DPCCH with SF of 128, where HS-DPCCH1 and HS-DPCCH2 are the physical channels using the same or separate channelization codes of SF=128. Each HS-DPCCH may carry two sets of HARQ-ACK and CQI (or PCI/CQI) messages. On HS-DPCCH1, A/N1 and A/N2 are carried on a first time slot 502, PCI/CQI1 is carried on a second time slot 504, and PCI/CQI2 is carried on a third time slot 506. On HS-DPCCH2, A/N3 and A/N4 are carried on a first time slot 502, PCI/CQI3 is carried on a second time slot 504, and PCI/CQI4 is carried on a third time slot 506. The two HS-DPCCHs may be carried on separate uplink carriers if dual (or multi) carrier uplink operation is supported, where there may be one HS-DPCCH on each uplink frequency.

If one HS-DPCCH with SF of 64 (i.e., slot format #2) is used, the HS-DPCCH may be mapped to a quadrature (Q) branch when N_{max-dpdch} (i.e., the maximum number of dedicated physical data channel) is configured to 0 or 1, and the channelization code may be allocated as shown in Table 2 or 3. Tables 2 and 3 show an example channelization code allocation for HS-DPCCH for different slot formats. C_{ch,x,y} means a y-th channelization code in an orthogonal variable spreading factor (OVSF) code tree with an SF of x.

TABLE 2

Channelization code Cₕₛ

| | HS-DPCCH | HS-DPCCH | HS-DPCCH |
|---|---|---|---|
| N_{max-dpdch} | slot format #0 | slot format #1 | slot format #2 |
| 0 | C_{ch, 256, 33} | C_{ch, 128, 16} | C_{ch, 64, 8} |
| 1 | C_{ch, 256, 64} | C_{ch, 128, 32} | C_{ch, 64, 16} |
| 2, 4, 6 | C_{ch, 256, 1} | N/A | N/A |
| 3, 5 | C_{ch, 256, 32} | N/A | N/A |

TABLE 3

Channelization code Cₕₛ

| | HS-DPCCH | HS-DPCCH | HS-DPCCH |
|---|---|---|---|
| N_{max-dpdch} | slot format #0 | slot format #1 | slot format #2 |
| 0 | C_{ch, 256, 33} | C_{ch, 128, 16} | C_{ch, 64, 9} |
| 1 | C_{ch, 256, 64} | C_{ch, 128, 32} | C_{ch, 64, 17} |
| 2, 4, 6 | C_{ch, 256, 1} | N/A | N/A |
| 3, 5 | C_{ch, 256, 32} | N/A | N/A |

Alternatively, the HS-DPCCH with SF of 64 may be mapped to an in-phase (I) branch when N_{max-dpdch} is configured to 0 or 1, and the channelization code may be defined as C_{ch,64,8}.

If two HS-DPCCHs with SF of 128 (HS-DPCCH1 and HS-DPCCH2) are used in 8C-HSDPA, the two HS-DPCCHs may be mapped to the same or different I/Q branches. In one embodiment, HS-DPCCH1 and HS-DPCCH2 may be mapped to Q/I or I/Q branches, respectively, on the same channelization code by using HS-DPCCH slot format #1 as defined in Table 1. HS-DPCCH1 and HS-DPCCH2 may be mapped to Q/I branches (i.e., Q/1 multiplexed) or I/Q branches with the same channelization code as follows: when N_{max-dpdch}=0, the channelization code may be (C_{ch,128,16}, C_{ch,128,16}), and when N_{max-dpdch}=1, the channelization code may be (C_{ch,128,16}, C_{ch,128,16}). (C_{ch,128,x}, C_{ch,128,y}) denotes a pair of channelization codes selected for dual HS-DPCCHs with SF=128 (i.e., HS-DPCCH slot format #1 in Table 1), where C_{ch,128,x} is the channelization code used for HS-DPCCH1 and C_{ch,128,y} is the channelization code used for HS-DPCCH2. Alternatively, HS-DPCCH1 and HS-DPCCH2 may be mapped to Q and I branches, respectively with the same channelization code as follows: when N_{max-dpdch}=0, the channelization code may be (C_{ch,128,16}, C_{ch,128,16}), and when N_{max-dpdch}=1, the channelization code may be (C_{ch,128,32}, C_{ch,128,32}).

In another embodiment, HS-DPCCH1 and HS-DPCCH2 may be mapped to Q/I or I/Q branches on different channelization codes. For example, when N_{max-dpdch}=1, HS-DPCCH1 may be mapped to Q branch with channelization code C_{ch,128,33} (or C_{ch,128,32}, or C_{ch,128,34} or C_{ch,128,35}) while HS-DPCCH2 may be mapped to I branch with channelization code C_{ch,128,16}. Alternatively, when N_{max-dpdch}=1, HS-DPCCH1 may be mapped to I branch with channelization code C_{ch,128,16} while HS-DPCCH2 may be mapped to Q branch with channelization code C_{ch,128,33}.

Alternatively, HS-DPCCH1 and HS-DPCCH2 may be mapped to Q and I branches, respectively, with a pair of the same or different channelization codes as follows: when N_{max-dpdch}=0, channelization codes may be (C_{ch,128,16}, C_{ch,128,16}), and when N_{max-dpdch}=1,channelization codes may be (C_{ch,128,35}, C_{ch,128,16}), (C_{ch,128,34}, C_{ch,128,16}), (C_{ch,128,33}, C_{ch,128,16}), or (C_{ch,128,32}, C_{ch,128,16}).

Alternatively, HS-DPCCH1 and HS-DPCCH2 may be mapped to I and Q branches, respectively, with a pair of different channelization codes as follows: when N_{max-dpdch}=0, channelization codes may be (C_{ch,128,16}, C_{ch,128,16}), and when N_{max-dpdch}=1, channelization codes may be (C_{ch,128,16}, C_{ch,128,33}).

In still another embodiment, HS-DPCCH1 and HS-DPCCH2 may be mapped to the same branch, (e.g., Q branch or I branch), on different channelization codes. Both HS-DPCCH1 and HS-DPCCH2 may be mapped to the Q branch with a pair of different channelization codes as follows: when N_{max-dpdch}=0, channelization codes may be (C_{ch,128,22}, C_{ch,128,6}), (C_{ch,128,23}, C_{ch,128,7}), or (C_{ch,128,29}, C_{ch,128,13}), and when N_{max-dpdch}=1, channelization codes may be (C_{ch,128,19}, C_{ch,128,51}) or (C_{ch,128,20}, C_{ch,128,52}).

Alternatively, both HS-DPCCH1 and HS-DPCCH2 may be mapped to I branch with a pair of different channelization codes as follows: when N_{max-dpdch}=0, the pair of channelization codes may be (C_{ch,128,24}, C_{ch,128,8}), and when N_{max-dpdch}=1, the pair of channelization codes may be (C_{ch,128,20}, C_{ch,128,4}), (C_{ch,128,9}, C_{ch,128,25}), (C_{ch,128,11}, C_{ch,128,26}), or (C_{ch,128,3}, C_{ch,128,19}).

In 8C-HSDPA, some of the configured cells (i.e., carriers) may be dynamically activated and deactivated by the network or autonomously activated and deactivated by the WTRU. When dual channelization codes with SF=128 are used for the 8C-HSDPA, (i.e., (C_{ch,128,x}, C_{ch,128,y}) are channelization codes used for HS-DPCCH1 and HS-DPCCH2, respectively), if no more than four cells are active upon activation or deactivation, one HS-DPCCH with SF=128 may be used, and the channelization code for the HS-DPCCH may be C_{ch,128,x} or C_{ch,128,y}. Alternatively, the channelization code may be C_{ch,128,16} when N_{max-dpdch}=0 and C_{ch,128,32} when N_{max-dpdch}=1.

Upon activation or deactivation, if no more than two cells are active or 3 cells are active but MIMO is not configured in any cell, one HS-DPCCH with SF=256 may be used, and the channelization code for the HS-DPCCH may be allocated as in Table 2, (slot format #0). When 5 cells (5C) or 6 cells (6C) are active and MIMO is not configured in any cell, one HS-DPCCH with SF=128 may be used, and the channelization code for the HS-DPCCH may be selected from one of the embodiments disclosed above.

FIG. 6 shows an example physical channel mapping for HARQ-ACK messages to one HS-DPCCH with SF=64 in accordance with one embodiment. The HARQ-ACK messages (HARQ-ACK1˜HARQ-ACK4) are channel coded (602) (i.e., a 10-bit codeword is selected for each HARQ-ACK message from the codebook) and the codewords are concatenated (604) as follows:
(w_{O} w₁ . . . w₉ w₁₀ . . . w₁₉ . . . w₂₉ . . . w₃₉)=(ack1₀ ack1₁ . . . ack1₉ ack2₀ ack2₁ . . . ack2₉ ack3₀ ack3₁ . . . ack3₉ ack4₀ ack4₁ . . . ack4₉).
   The concatenated codewords are mapped to physical channel(s) (606) and transmitted over the air in an ascending order, (or alternatively in a descending order).

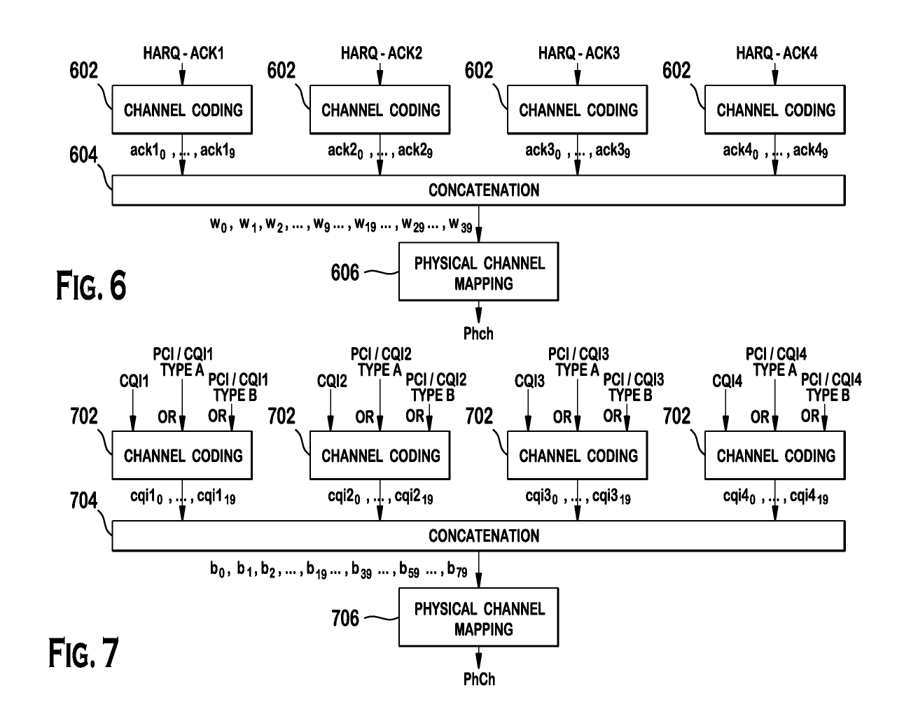

FIG. 7 shows an example physical channel mapping for CQI (or PCI/CQI) messages to one HS-DPCCH with SF=64 in accordance with one embodiment. The CQI messages in non-MIMO (or type A or type B PCI/CQI messages in MIMO) are channel coded (702), and the channel coded bits are concatenated (704) as follows:
(b₀ b₁ . . . b₁₉ b₂₀ b₂₁ . . . b₃₉ b₄₀ . . . b₅₉ b₆₀ . . . b₇₉)=(cqi1₀ cqi1₁ . . . cqi1₁₉ cqi2₀ cqi2₁ . . . cqi2₁₉ cqi3₀ cqi3₁ . . . cqi3₁₉ cqi4₀ cqi4₁ . . . cqi4₁₉)
   The concatenated bits are mapped to physical channel(s) (706) and transmitted over the air in an ascending order, (or alternatively in a descending order).

FIG. 8 shows an example physical channel mapping for HARQ-ACK messages to two HS-DPCCHs with SF=128 in accordance with one embodiment. The HS-DPCCHs may operate with four sets of feedback messages as disclosed in FIG. 5. FIG. 8 shows mapping of HARQ-ACK3 and HARQ-ACK4 messages to HS-DPCCH2 only for simplicity, and the same processing may be performed for HARQ-ACK1 and HARQ-ACK2 messages. The HARQ-ACK messages (HARQ-ACK3 and HARQ-ACK4 in FIG. 8) are channel coded (802) (i.e., a 10-bit codeword is selected for each HARQ-ACK message from the codebook) and the codewords are concatenated (804) as follows:
(w₀ w₁ . . . w₉ w₁₀ w₁₁ . . . w₁₉)=(ack3₀ ack3₁ . . . ack3₀ ack4₀ ack4₁ . . . ack4₉).
   The concatenated bits are mapped to physical channel(s) (806) and transmitted over the air in an ascending order, (or alternatively in a descending order).

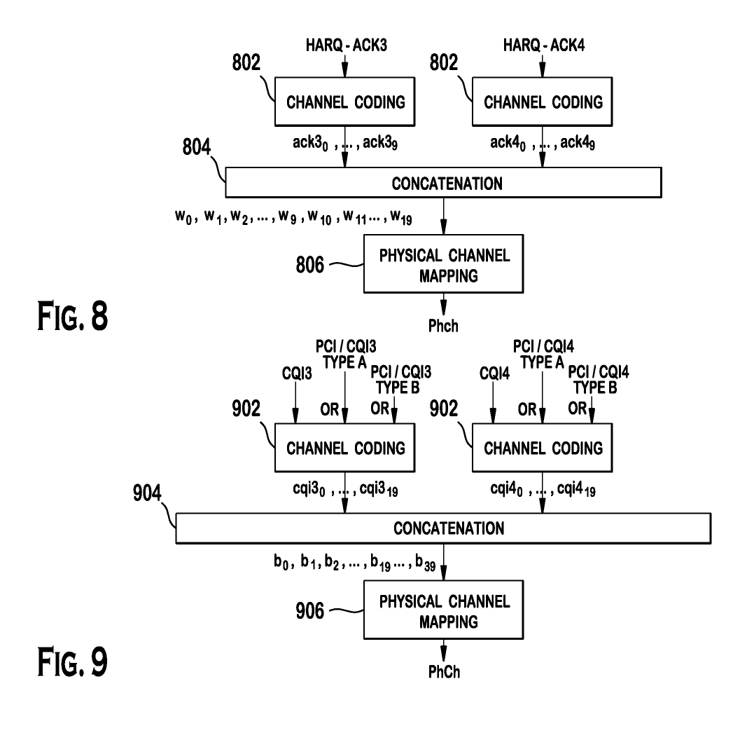

FIG. 9 shows an example physical channel mapping for CQI (or PCI/CQI) messages to two HS-DPCCHs with SF=128 in accordance with one embodiment. The HS-DPCCHs may operate with four sets of the feedback messages as shown in FIG. 5. FIG. 9 shows mapping of CQI3 (or PCI/CQI3) and CQI4 (or PCI/CQI4) messages to HS-DPCCH2 only for simplicity, and the same processing may be performed for CQI1 (or PCI/CQI1) and CQI2 (or PCI/CQI2) messages. The CQI (or PCI/CQI) messages (CQI3 (or PCI/CQI3) and CQI4 (or PCI/CQI4) in this example) are channel coded (902) and the channel coded bits are concatenated (904) as follows:
(b₀ b₁ . . . b₁₉ b₂₀ b₂₁ . . . b₃₉)=(cqi3₀ cqi3₁ . . . cqi3₁₉ cqi4₀ cqi4₁ . . . cqi4₁₉).
   The concatenated bits are mapped to physical channel(s) (906) and transmitted over the air in an ascending order, (or alternatively in a descending order).

Embodiments for association between a feedback message (either HARQ-ACK or CQI (or PCI/CQI) message) and the corresponding downlink HS-DSCH carriers (or cells) are disclosed hereafter.

A WTRU is configured by the network via RRC signaling with a serving HS-DSCH cell and up to seven secondary serving HS-DSCH cells. The eight downlink serving cells may be grouped by pair. The HARQ-ACK states (i.e., ACK or NACK states) for each pair of cells are combined to form an HARQ-ACK message, denoted by HARQ-ACKn, where n=1, 2, 3, 4. Table 4 shows an example association of the HARQ-ACK messages to the serving cells. Each of the HARQ-ACK messages may be placed under two serving cells, representing the fact that the HARQ-ACK feedbacks for these two cells are combined into the corresponding HARQ-ACK message.

TABLE 4

| | | | | | | | |
|---|---|---|---|---|---|---|---|
| | 1^{st} | 2^{nd} | 3^{rd} | 4th | 5th | 6th | 7th |
| Serving | Secondary | Secondary | Secondary | Secondary | Secondary | Secondary | Secondary |
| HS- | Serving | Serving | Serving | Serving | Serving | Serving | Serving |
| DSCH | HS-DSCH | HS-DSCH | HS-DSCH | HS-DSCH | HS-DSCH | HS-DSCH | HS-DSCH |
| cell | cell | cell | cell | cell | cell | cell | cell |

| | | | |
|---|---|---|---|
| HARQ-ACK1 | HARQ-ACK2 | HARQ-ACK3 | HARQ-ACK4 |

For CQI reporting, (20,7/10) or (20,5) Reed Muller coding may be used to encode the CQI (or PCI/CQI) messages, (i.e., the CQI or PCI/CQI values are mapped to 5, 7, or 10 bits of CQI (or PCI/CQI) messages, and the CQI (or PCI/CQI) messages are encoded by (20,7/10) or (20,5) coding to 20 bits). The CQI (or PCI/CQI) information for each cell may be encoded individually and independently. Therefore, up to 8 CQI (or PCI/CQI) messages are generated for the cells, which would not fit in one HS-DPCCH sub-frame as it supports maximum 4 CQI (or PCI/CQI) messages as seen in FIGS. 2-5. Some (e.g., 4) CQI (or PCI/CQI) messages may be transmitted in a different HS-DPCCH sub-frame, which will lead to the minimum CQI feedback cycle equal to or greater than two sub-frames (4 ms). Table 5 shows an example association of serving cells to the CQI (or PCI/CQI) messages in accordance with one embodiment, where the second PCI/CQI report is transmitted in a different sub-frame from the first PCI/CQI report. The two related HS-DPCCH sub-frames may or may not be consecutive in time, depending on the CQI feedback cycle or other network settings.

TABLE 5

| | | | | |
|---|---|---|---|---|
| 1st | Serving HS- | 2nd | 4th | 6th |
| PCI/CQI | DSCH cell | Secondary | Secondary | Secondary |
| report | | Serving HS- | Serving HS- | Serving HS- |
| | | DSCH cell | DSCH cell | DSCH cell |
| | PCI/CQI 1 | PCI/CQI 2 | PCI/CQI 3 | PCI/CQI 4 |
| 2nd | 1st | 3rd | 5th | 7th |
| PCI/CQI | Secondary | Secondary | Secondary | Secondary |
| report | Serving HS- | Serving HS- | Serving HS- | Serving HS- |
| | DSCH cell | DSCH cell | DSCH cell | DSCH cell |
| | PCI/CQI 1 | PCI/CQI 2 | PCI/CQI 3 | PCI/CQI 4 |

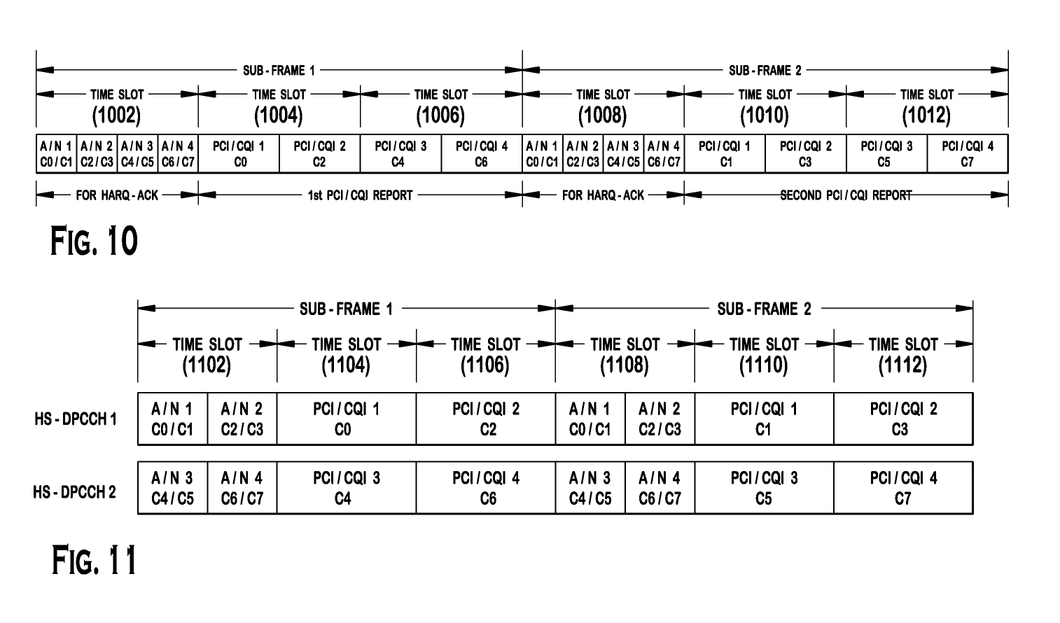

FIG. 10 shows the carrier association for one HS-DPCCH with SF=64, where the CQI (or PCI/CQI) reports are transmitted over two sub-frames in accordance with the association examples above (Tables 4 and 5). C0 refers to the serving HS-DSCH cell, C1 refers to the first secondary serving HS-DSCH cell, C2 refers to the second secondary serving HS-DSCH cell, and so on. A/N1 through A/N4 for C0 through C8 are transmitted on first time slots 1002, 1008 of the subframe 1 and subframe 2, and a first CQI (or PCI/CQI) report for cells C0, C2, C4, and C6 are transmitted on second and third time slots 1004, 1006 of subframe 1, and a second CQI (or PCI/CQI) report for cells C1, C3, C5, and C7 are transmitted on second and third time slots 1010, 1012 of subframe 2.

FIG. 11 shows the carrier association for two HS-DPCCHs with SF=128, where the CQI (or PCI/CQI) reports are transmitted over two sub-frames in accordance with the association examples above (Tables 4 and 5). A/N1 through A/N4 for C0 through C8 are transmitted on first time slots 1102, 1108 of the subframe 1 and subframe 2 on HS-DPCCH1 and HS-DPCCH2, and a first CQI (or PCI/CQI) report for cells C0, C2, C4, and C6 are transmitted on second and third time slots 1104, 1106 of subframe 1 on HS-DPCCH1 and HS-DPCCH2, and a second CQI (or PCI/CQI) report for cells C1, C3, C5, and C7 are transmitted on second and third time slots 1110, 1112 of subframe 2 on HS-DPCCH1 and HS-DPCCH2.

Embodiments for carrier association to the HARQ-ACK messages upon activation/deactivation of the carriers are disclosed hereafter. Some of the configured cells may be dynamically activated and deactivated by the network, or a WTRU may not be configured with all 8 carriers. When a secondary serving cell is not active, there is no HARQ-ACK and CQI (or PCI/CQI) information to be sent with respect to that inactive secondary serving cell. If secondary serving cells in a pair associated with a particular HARQ-ACK message are both deactivated, no transmission of any signal to the air may occur over the corresponding time interval.

In case one HS-DPCCH with SF=64 is configured, since with SF=64, four HARQ-ACK messages may be allocated to a time slot (e.g., time slot 202 as shown in FIG. 2), a non-full-slot transmission may occur if each individual HARQ-ACK message (i.e., any one of A/N1-A/N4 in FIG. 2) is allowed to be discontinuously transmitted (DTXed), (i.e., the corresponding HARQ-ACK section of the slot is not transmitted).

In one embodiment, in order to avoid the non-full-slot transmission for the HARQ-ACK slots when one HS-DPCCH with SF=64 is configured, the carrier association to the HARQ-ACK messages may be dynamically updated depending on the carrier activation/deactivation status. A carrier, (i.e., a serving cell), may be remapped to a different HARQ-ACK message if activation or deactivation of a cell(s) occurs. The dynamic carrier association may be performed in such way that empty HARQ-ACK message slots are made available as much as possible and after the remapping, the empty HARQ-ACK message slots may be filled by repeating other HARQ-ACK messages to increase redundancy and improving transmission reliability.

Whenever an activation or deactivation of a serving cell (or cells) occurs, the remaining active serving cells may be reordered, for example, according to their labels in an ascending or descending order (e.g., the serving HS-DSCH cell is labeled 0^{th}). The ordered serving cells are grouped by pair. The last pair is allowed to contain only one serving cell if the number of active cells is odd. The HARQ-ACK states of each pair of the cells are combined and assigned to one of the HARQ-ACK messages.

Repetition of the HARQ-ACK information may be performed depending on the number of active secondary serving cells. If the number of active cells is 1 or 2 (i.e., Secondary_Cell_Active=0 or 1), HARQ-ACK1 is prepared and repeated across all other three HARQ-ACK messages. If the number of active cells is 3 or 4 (i.e., Secondary_Cell_Active=2 or 3), HARQ-ACK1 and HARQ-ACK2 are prepared and may be repeated in HARQ-ACK3 and HARQ-ACK4, respectively. If the number of active cells is 5 or 6 (i.e., Secondary_Cell_Active=4 or 5), HARQ-ACK1, HARQ-ACK2, and HARQ-ACK3 are prepared, and one of them is repeated in HARQ-ACK4. In this case, HARQ-ACK1 may be repeated where a serving HS-DSCH cell is supported. Alternatively, HARQ-ACK1 to HARQ-ACK3 may be repeated in a time division multiplexing (TDM) fashion. Alternatively, one of HARQ-ACK2 or HARQ-ACK3 may be repeated.

Table 6 shows an example dynamic carrier association in accordance with one embodiment. Denote C0 as the serving HS-DSCH cell, and C1, . . . , Cn (where n=Secondary_Cell_Active) as the active secondary serving HS-DSCH cells after relabeling according to one of the above reordering and remapping embodiments. For example, if the first and fourth secondary serving cells remain active after carrier deactivation, C1 becomes the first secondary serving cell, and C2 becomes the fourth secondary serving cell.

TABLE 6

| | HARQ- | HARQ- | HARQ- | HARQ- |
|---|---|---|---|---|
| Secondary_Cell_Active | ACK1 | ACK2 | ACK3 | ACK4 |
| 0 | C0 | C0 | C0 | C0 |
| 1 | C0/C1 | C0/C1 | C0/C1 | C0/C1 |
| 2 | C0/C1 | C2 | C0/C1 | C2 |
| 3 | C0/C1 | C2/C3 | C0/C1 | C2/C3 |
| 4 | C0/C1 | C2/C3 | C4 | C0/C1 |
| 5 | C0/C1 | C2/C3 | C4/C5 | C0/C1 |
| 6 | C0/C1 | C2/C3 | C4/C5 | C6 |
| 7 | C0/C1 | C2/C3 | C4/C5 | C6/C7 |

Table 7 shows another example of dynamic carrier association. In this example, more emphasis of reliability is placed on the serving HS-DSCH cell (C0). Alternatively, any rows in Table 6 and Table 7 may be combined to form a new table for the carrier association.

TABLE 7

| | HARQ- | HARQ- | HARQ- | HARQ- |
|---|---|---|---|---|
| Secondary_Cell_Active | ACK1 | ACK2 | ACK3 | ACK4 |
| 0 | C0 | C0 | C0 | C0 |
| 1 | C0/C1 | C0/C1 | C0/C1 | C0/C1 |
| 2 | C0 | C1/C2 | C0 | C1/C2 |
| 3 | C0/C1 | C2/C3 | C0/C1 | C2/C3 |
| 4 | C0 | C1/C2 | C3/C4 | C0 |
| 5 | C0/C1 | C2/C3 | C4/C5 | C0/C1 |
| 6 | C0 | C1/C2 | C3/C4 | C5/C6 |
| 7 | C0/C1 | C2/C3 | C4/C5 | C6/C7 |

In another embodiment, the configured serving cells may be divided into two groups and dynamic carrier association may be performed within the group. For example, the serving cells in the first group are associated or remapped to HARQ-ACK1 and HARQ-ACK2, and serving cells in the second group are associated or remapped to HARQ-ACK3 and HARQ-ACK4. If an HARQ-ACK message in one group is empty because there is not enough active serving cells associated with it, the other HARQ-ACK message within the group may be repeated for that empty HARQ-ACK message. If the entire group is empty, the HARQ-ACK messages of the other group may be repeated in the HARQ-ACK messages of the empty group.

Table 8 shows an example dynamic carrier association in accordance with this embodiment. Denote C0 as the primary serving cell (i.e., serving HS-DSCH cell), C11, C12, . . . , C1n, n=1, 2, 3, as the active secondary cells (i.e., secondary HS-DSCH cells) in group 1, and C21, C22, . . . , C2m, m=1, 2, 3, 4, as the active secondary cells in group 2. In Table 8, Secondary_Cell_Active1 is the number of the active secondary serving cells in group 1 and Secondary_Cell_Active2 is the number of the active secondary serving cells in group 2.

TABLE 8

| | | | HARQ- | HARQ- | HARQ- | HARQ- |
|---|---|---|---|---|---|---|
| Secondary_Cell_Active | Secondary_Cell_Active1 | Secondary_Cell_Active2 | ACK1 | ACK2 | ACK3 | ACK4 |
| 0 | 0 | 0 | C0 | C0 | C0 | C0 |
| 1 | 0 | 1 | C0 | C0 | C21 | C21 |
| 2 | 0 | 2 | C0 | C0 | C21/C22 | C21/C22 |
| 3 | 0 | 3 | C0 | C0 | C21/C22 | C23 |
| 4 | 0 | 4 | C0 | C0 | C21/C22 | C23/C24 |
| 1 | 1 | 0 | C0/C11 | C0/C11 | C0/C11 | C0/C11 |
| 2 | 1 | 1 | C0/C11 | C0/C11 | C21 | C21 |
| 3 | 1 | 2 | C0/C11 | C0/C11 | C21/C22 | C21/C22 |
| 4 | 1 | 3 | C0/C11 | C0/C11 | C21/C22 | C23 |
| 5 | 1 | 4 | C0/C11 | C0/C11 | C21/C22 | C23/C24 |
| 2 | 2 | 0 | C0/C11 | C12 | C0/C11 | C12 |
| 3 | 2 | 1 | C0/C11 | C12 | C21 | C21 |
| 4 | 2 | 2 | C0/C11 | C12 | C21/C22 | C21/C22 |
| 5 | 2 | 3 | C0/C11 | C12 | C21/C22 | C23 |
| 6 | 2 | 4 | C0/C11 | C12 | C21/C22 | C23/C24 |
| 3 | 3 | 0 | C0/C11 | C12/C13 | C0/C11 | C12/C13 |
| 4 | 3 | 1 | C0/C11 | C12/C13 | C21 | C21 |
| 5 | 3 | 2 | C0/C11 | C12/C13 | C21/C22 | C21/C22 |
| 6 | 3 | 3 | C0/C11 | C12/C13 | C21/C22 | C23 |
| 7 | 3 | 4 | C0/C11 | C12/C13 | C21/C22 | C23/C24 |

Table 9 shows another example dynamic carrier association. In this example, HARQ1 and HARQ2 are allowed for more single carrier configuration. Alternatively, any rows in Table 8 and Table 9 may be combined to form a new carrier association table.

TABLE 9

| | | | HARQ- | HARQ- | HARQ- | HARQ- |
|---|---|---|---|---|---|---|
| Secondary_Cell_Active | Secondary_Cell_Active1 | Secondary_Cell_Active2 | ACK1 | ACK2 | ACK3 | ACK4 |
| 0 | 0 | 0 | C0 | C0 | C0 | C0 |
| 1 | 0 | 1 | C0 | C0 | C21 | C21 |
| 2 | 0 | 2 | C0 | C0 | C21/C22 | C21/C22 |
| 3 | 0 | 3 | C0 | C0 | C21 | C22/C23 |
| 4 | 0 | 4 | C0 | C0 | C21/C22 | C23/C24 |
| 1 | 1 | 0 | C0/C11 | C0/C11 | C0/C11 | C0/C11 |
| 2 | 1 | 1 | C0/C11 | C0/C11 | C21 | C21 |
| 3 | 1 | 2 | C0/C11 | C0/C11 | C21/C22 | C21/C22 |
| 4 | 1 | 3 | C0/C11 | C0/C11 | C21 | C22/C23 |
| 5 | 1 | 4 | C0/C11 | C0/C11 | C21/C22 | C23/C24 |
| 2 | 2 | 0 | C0 | C11/C12 | C0/C11 | C12 |
| 3 | 2 | 1 | C0 | C11/C12 | C21 | C21 |
| 4 | 2 | 2 | C0 | C11/C12 | C21/C22 | C21/C22 |
| 5 | 2 | 3 | C0 | C11/C12 | C21 | C22/C23 |
| 6 | 2 | 4 | C0 | C11/C12 | C21/C22 | C23/C24 |
| 3 | 3 | 0 | C0/C11 | C12/C13 | C0/C11 | C12/C13 |
| 4 | 3 | 1 | C0/C11 | C12/C13 | C21 | C21 |
| 5 | 3 | 2 | C0/C11 | C12/C13 | C21/C22 | C21/C22 |
| 6 | 3 | 3 | C0/C11 | C12/C13 | C21 | C22/C23 |
| 7 | 3 | 4 | C0/C11 | C12/C13 | C21/C22 | C23/C24 |

In another embodiment, the carrier association may be made semi-dynamic by not allowing remapping. When a secondary serving cell is active, its association to an HARQ-ACK message may not change once it is configured by the network. When all the secondary serving cells assigned to the same HARQ-ACK message are deactivated, the corresponding HARQ-ACK field may not have signal to transmit, leading to a non-full-slot transmission. The non-full-slot transmission may be avoided by repeating transmission of other HARQ-ACK messages. For example, HARQ-ACK1 (associated with the serving HS-DSCH cell) may be repeated if there is no HARQ-ACK message associated to any of the active serving cells because they are either deactivated or not configured.

In another embodiment, the carrier association may be fixed, and no remapping and repeating may be performed upon activation/deactivation of the secondary serving cells. If both cells supported by an HARQ-ACK message are deactivated or not configured, the non-full-slot transmission may be avoided by sending a DTX codeword.

In a case where two HS-DPCCHs with SF of 128 are used, two HARQ-ACK fields are included in the first time slot of the HS-DPCCH sub-frame on HS-DPCCH1 and HS-DPCCH2 as shown in FIG. 5. A half-slot transmission may occur if any individual HARQ-ACK message is allowed to be DTXed. In order to avoid the non-full-slot transmission for HARQ-ACK field when two HS-DPCCHs with SF=128 are configured, per-channel remapping and/or repetition may be performed upon activation/deactivation of any secondary serving HS-DSCH cell, (i.e., remapping and/or repetition may be independently performed within each HS-DPCCH, either HS-DPCCH1 or HS-DPCCH2) so that the HARQ-ACK information associated with the serving HS-DSCH cell, the 1^{st}, 2^{nd}, and 3^{rd} secondary serving HS-DSCH cells may always be transmitted on HS-DPCCH1 and the HARQ-ACK information associated with the 4^{th}, 5^{th}, 6^{th}, and 7^{th} secondary serving HS-DSCH cells may be transmitted on HS-DPCCH2 whenever they needs to be transmitted (i.e., no remapping of HARQ-ACK between two HS-DPCCHs). More specifically, the secondary HS-DPCCH which is the other HS-DPCCH not associated with the serving HS-DSCH cell (e.g., HS-DPCCH2 as shown in FIG. 11) may follow the remapping and repetition rule upon activation/deactivation below.

In a case of 4 active cells in the secondary HS-DPCCH (HS-DPCCH2), neither remapping nor repeating is needed. The two HARQ-ACK messages (each HARQ-ACK message corresponds to a pair of cells) are encoded and concatenated into the same slot in a pre-defined order (e.g., in ascending order or alternatively in descending order with respect to the numbering of active carriers). For example, HARQ-ACK3 may comprise the HARQ acknowledgement messages for the pair of the fourth secondary serving HS-DSCH cell and the fifth secondary serving HS-DSCH cell in that order and HARQ-ACK4 may comprise the HARQ acknowledgement messages for the pair of the sixth secondary serving HS-DSCH cell and the seventh secondary serving HS-DSCH cell in that order.

In a case of 3 activated cells in the secondary HS-DPCCH, HARQ-ACK messages are transmitted in the same way as the case of 4 activated cells except a DTX message is transmitted in place of the deactivated secondary serving cell. In this case, carrier association remapping may or may not be performed and no repeating is needed.

In a case of 2 activated cells in the secondary HS-DPCCH, the HARQ-ACK message for a pair of the secondary serving HS-DSCH cells with a lowest index as indicated by higher layers and the other activated secondary serving HS-DSCH cell in that order are jointly encoded and repeated to fill the whole HARQ-ACK slot of the HS-DPCCH subframe.

In a case of 1 activated cell in the secondary HS-DPCCH, the HARQ-ACK message for the active cell is jointly coded with DTX and repeated to fill the whole HARQ-ACK slot of the HS-DPCCH subframe.

In a case of 0 activated cells in the secondary HS-DPCCH, the whole HARQ-ACK slot in the HS-DPCCH sub-frame may be DTXed or filled (and repeated) with a DTX codeword (i.e., D/D). If the WTRU does not detect HS-SCCH for any of the cells whose HARQ-ACK information is mapped to the same HS-DPCCH but at least one HS-SCCH is detected for a cell whose HARQ-ACK information is mapped to the other HS-DPCCH, then the WTRU may repeat the DTX codeword in the HARQ-ACK field of the HS-DPCCH for which it did not detect any HS-SCCH transmissions.

In another embodiment, cross-channel remapping and repetition may be performed upon activation or deactivation of any serving cell, (i.e., carrier association remapping and/or repetition may be performed across the two HS-DPCCHs (HS-DPCCH1 and HS-DPCCH2). If the number of active serving cells is 1 (i.e., Secondary_Cell_Active=0), the HARQ-ACK status information for the serving HS-DSCH cell is jointly coded with DTX and repeated to fill the whole HARQ-ACK slot in HS-DPCCH1 while HS-DPCCH2 is DTXed. If the number of active serving cells is 2 (i.e., Secondary_Cell_Active=1), the HARQ-ACK status information for the serving HS-DSCH cell and the active secondary serving HS-DSCH cell are jointly encoded and repeated to fill the whole HARQ-ACK slot in HS-DPCCH1 while HS-DPCCH2 is DTXed. If the number of active serving cells is 3 or 4, (i.e., Secondary_Cell_Active=2 or 3), the HARQ-ACK status information for the three or four serving cells are remapped and regrouped for HARQ-ACK1 and HARQ-ACK2, which fill the whole HARQ-ACK slot in HS-DPCCH1 while HS-DPCCH2 is DTXed. If the number of active serving cells is 5 or more, (i.e., Secondary_Cell_Active>3), the HARQ-ACK status information for the four active cells (including the serving HS-DSCH cell) may be regrouped and remapped to HARQ-ACK1 and HARQ-ACK2, which fill the whole HARQ-ACK slot in HS-DPCCH1, and the remaining active secondary serving cells may be remapped to HARQ-ACK3 (and HARQ-ACK4 if necessary), and repeated if necessary, to fill the HARQ-ACK slot in HS-DPCCH2.

In a special case where the number of active serving cells is three to six and MIMO is not configured in any cell, three cells may be grouped into one group and the remaining cells may be grouped into another group. The HARQ-ACK status information in each group (up to 3) may be jointly encoded, respectively, in accordance with the coding scheme for the 3C without MIMO, and the two HARQ-ACK codewords may fill the HARQ-ACK slot of one HS-DPCCH with SF of 128.

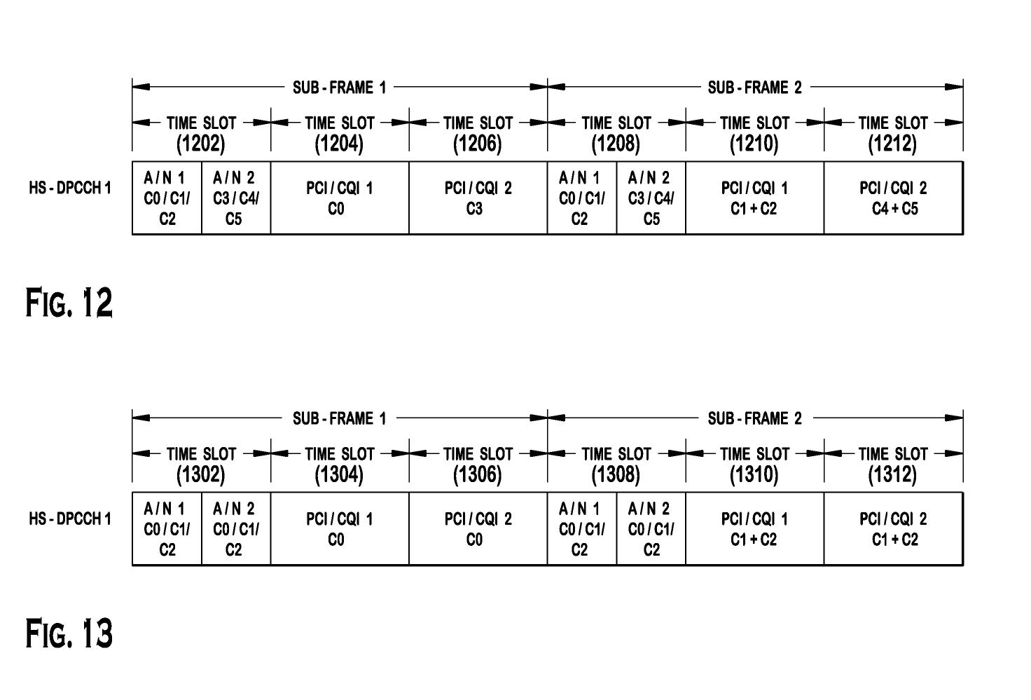

FIG. 12 shows an example message layout format for one HS-DPCCH with SF of 128 for 6C without MIMO. A/N1 for C0 through C2 and A/N2 for C3 through C5 are transmitted on first time slots 1202, 1208 of the subframe 1 and subframe 2, respectively, and a first CQI report for cells C0 and C3 are transmitted on second and third time slots 1204, 1206 of subframe 1, respectively, and a second CQI report for cells C1+C2 and C4+C5 are transmitted on second and third time slots 1210, 1212 of subframe 2, respectively.

In another special case where the number of active serving cells is three, the active cells are grouped into one group and the HARQ-ACK status information for the three cells is jointly encoded in accordance with the coding scheme for the 3C without MIMO, and then the codeword is repeated to fill-in the whole HARQ-ACK slot of one HS-DPCCH with SF of 128.

FIG. 13 shows an example message layout format for one HS-DPCCH with SF of 128 for 3C without MIMO. A/N for C0 through C2 is repeated on a first time slot 1302, 1308 of the subframe 1 and subframe 2, respectively, and a first CQI report for C0 is transmitted (repeated) on second and third time slots 1304, 1306 of subframe 1, and a second CQI report for C1 and C2 is transmitted (repeated) on second and third time slots 1310, 1312 of subframe 2.

Alternatively, remapping may not be allowed but repeating may be allowed when 2 HS-DPCCHs with SF of 128 are used. When a secondary serving cell is active, its association to an HARQ-ACK message may not be changed once it is configured by the network, and when the secondary serving cells assigned to the same HARQ-ACK message are deactivated, the non-full-slot transmission may be avoided by repeating feedback information from other HARQ-ACK messages.

Alternatively, no remapping and repeating may be performed upon activation/deactivation of the secondary serving cells when 2 HS-DPCCHs with SF of 128 are used. If both cells associated with an HARQ-ACK message are deactivated or not configured, a non-full-slot transmission may be avoided by sending a DTX codeword.

Alternatively, in a case where 4 cells in HS-DPCCH2 are activated while one or more secondary serving cells in HS-DPCCH1 are deactivated, cross-channel remapping may not be allowed, and remapping and/or repeating of HARQ-ACK message may be performed within HS-DPCCH1.

In another embodiment, the carrier association may be made semi-dynamic by not allowing remapping but allowing repeating when 2 HS-DPCCHs with SF of 128 are used. When a secondary serving cell is active, its association to an HARQ-ACK message may not be changed once it is configured by the network. When the secondary serving cells assigned to the same HARQ-ACK message are deactivated, the non-full-slot transmission may be avoided by repeating feedback information from other HARQ-ACK messages. For example, HARQ-ACK1 may be repeated if an HARQ-ACK2 message is not associated to any of the active serving cells.

In another embodiment, the carrier association may be fixed, (i.e., no remapping and repeating is performed upon activation/deactivation of the secondary serving cells when 2 HS-DPCCHs with SF of 128 are used). If both cells associated with an HARQ-ACK message are deactivated or not configured, the non-full-slot transmission may be avoided by sending a DTX codeword.

Embodiments for CQI reporting restrictions upon activation and deactivation of a secondary serving cell(s) are disclosed hereafter.

When a secondary serving cell(s) is deactivated, a CQI (or PCI/CQI) report pertaining to the inactive serving cell(s) may not be sent. In addition, a WTRU may not send a CQI (or PCI/CQI) in some sub-frames following the network configuration (e.g., a large CQI feedback cycle is configured by the network). In any of these events, a half-slot transmission may occur because the individual CQI message takes a half time slot interval when one HS-DPCCH with SF of 64 is configured. In case where one HS-DPCCH with SF=64 is used, the following embodiments may be implemented in order to avoid the half-slot transmissions.

In one embodiment, a pair of the serving cells corresponding to the CQI messages reported in the same time slot may be required to report CQIs simultaneously. In other words, sending only one of the CQI messages in a time slot may not be allowed. For example, C4 and C6 in FIG. 10 may not be allowed to be sent alone.

In a case where some of the secondary serving cells are deactivated that may result in a half-slot transmission, the CQI messages placed in another half slot in the same time slot may be repeated to fill the full time slot. Alternatively, a new CQI DTX codeword may be introduced, which may be a new CQI value not used for the normal range of CQI value, (e.g., CQI value=0 or CQI value=31 for the case without MIMO configured or MIMO configured and single-stream restriction configured; or CQI value=15 for case with MIMO configured and single-stream restriction not configured), to replace the CQI for the deactivated cell to avoid a half-slot transmission. Alternatively, a half-slot transmission may be allowed by DTXing the transmission for the deactivated cell. Alternatively, the active cells may be regrouped and/or remapped so that a pair of active cells fill in one slot. In a case of an odd number of active cells, one of the active cells may be repeated, or paired with a CQI DTX codeword, or DTXed.

While configured with 2 HS-DPCCHs with SF of 128, upon activation/deactivation of the secondary serving HS-DSCH cells, the serving cells may be regrouped, remapped and/or repeated for the CQI (or PCI/CQI) reporting.

In one embodiment, per-channel repetition may be used for CQI reporting (i.e., per-channel CQI repetition may be independently performed within each HS-DPCCH, (either HS-DPCCH1 or HS-DPCCH2)) when 2 HS-DPCCHs with SF of 128 are configured in 8C-HSDPA so that the CQI information associated with the serving HS-DSCH cell, the 1^{st}, 2^{nd}, and 3^{rd} secondary serving HS-DSCH cells may always be transmitted on HS-DPCCH1 and the CQI information associated with the 4^{th}, 5^{th}, 6^{th}, and 7^{th} secondary serving HS-DSCH cells may be transmitted on HS-DPCCH2 whenever they need to be transmitted (i.e., no remapping of CQI information between two HS-DPCCHs). In a case where four cells are active on an HS-DPCCH, CQI or PCI/CQI messages of two active cells are transmitted in one subframe of the HS-DPCCH, and CQI or PCI/CQI messages of the other two active cells are transmitted in another subframe of the HS-DPCCH in a pre-defined order. For example, for HS-DPCCH2, the report for the 4th secondary serving HS-DSCH cell (CQI 3 or PCI/CQI 3) and the 6th secondary serving HS-DSCH cell (CQI 4 or PCI/CQI 4) are mapped according to FIG. 9, and the report for the 5th secondary serving HS-DSCH cell (CQI 3 or PCI/CQI 3) and the 7th secondary serving HS-DSCH cell (CQI 4 or PCI/CQI 4) are mapped according to FIG. 9. When Secondary_Cell_Active is less than 7 the mapping of the CQI or PCI/CQI reports may be the same as the case when Secondary_Cell_Active is 7 with the following exceptions.

In a case where three cells are active on an HS-DPCCH, the HS-DPCCH physical channel mapping function may map the input bits bₖ directly to the physical channel in the corresponding slot of the CQI (or PCI/CQI) field of that subframe while the other slot of the CQI (or PCI/CQI) field is DTXed in the subframe in which only one active cell is mapped.

In a case where two cells are active on an HS-DPCCH, the active cells are remapped within the HS-DPCCH such that a CQI or PCI/CQI message of one cell is transmitted in one subframe of the HS-DPCCH and a CQI or PCI/CQI message of the other cell is transmitted in another subframe of the HS-DPCCH, wherein each CQI or PCI/CQI message is repeated to fill in the CQI slots of the corresponding subframe.

In a case where one cell is active on an HS-DPCCH, a CQI or PCI/CQI message of the active cell may be repeated over the two slots of one HS-DPCCH subframe. The above physical channel mapping rules upon the activation/deactivation of secondary serving HS-DSCH cells are applied to both primary and secondary HS-DPCCHs. Assuming that a serving HS-DSCH cell is associated with HS-DPCCH1, which may be always activated, there is a special case where all secondary serving HS-DSCH cells in HS-DPCCH2 are deactivated, and thus two CQI (or PCI/CQI) slots of HS-DPCCH2 subframe may be DTXed or filled by repeating a CQI DTX codeword.

In another embodiment, a cross-channel remapping and/or repetition may be performed for CQI reporting when 2 HS-DPCCHs with SF of 128 are configured in 8C-HSDPA. If the number of active secondary serving cells is equal to 0 (i.e., Secondary_Cell_Active=0), the CQI or PCI/CQI for the serving HS-DSCH cell may be repeated to fill the two slot CQI or PCI/CQI field in HS-DPCCH1 sub-frames while HS-DPCCH2 may be DTXed.

If the number of active secondary serving cells is equal to 1 (i.e., Secondary_Cell_Active=1), the CQI or PCI/CQI for each active cell may be repeated to fill the two slot CQI or PCI/CQI fields in HS-DPCCH1 sub-frame while HS-DPCCH2 may be DTXed. In a case where the activated secondary serving HS-DSCH cell is associated with HS-DPCCH2 before activation/deactivation, the CQI or PCI/CQI for the active secondary serving HS-DSCH cell may be remapped to two slots of HS-DPCCH1 when HS-DPCCH2 is DTXed.

If the number of active secondary serving cells is equal to 2 or 3 (i.e., Secondary_Cell_Active=2 or 3), the CQI or PCI/CQI for the active cells may be remapped to 4 slots of the first and second CQI or PCI/CQI reports of the two HS-DPCCH1 sub-frames while HS-DPCCH2 may be DTXed. A first CQI or PCI/CQI report is the four CQI or PCI/CQI messages mapped to a first HS-DPCCH subframe, and a second CQI or PCI/CQI report is the other four CQI or PCI/CQI messages mapped to subsequent HS-DPCCH subframe. In FIG. 11, C0, C2, C4, and C6 comprise the first CQI or PCI/CQI report, and C1, C3, C5, and C7 comprise the second CQI or PCI/CQI report.

In a case where the Secondary_Cell_Active=2, one of 4 slots of two HS-DPCCH1 sub-frames for the CQI or PCI/CQI reporting may be DTXed or filled by a CQI DTX codeword.

If Secondary_Cell_Active>3, four active cells (including the serving HS-DSCH cell) may be remapped to the first and second CQI or PCI/CQI reports carried on HS-DPCCH1, and the remaining active secondary serving HS-DSCH cells may be remapped to the first and/or second CQI or PCI/CQI reports carried on HS-DPCCH2 depending on the number of active secondary serving HS-DSCH cells. In a case of Secondary_Cell_Active=4 or 5, the CQI or PCI/CQI for each active secondary serving HS-DSCH cell remapped to HS-DPCCH2 may be repeated to fill the two slot CQI or PCI/CQI field in HS-DPCCH2. In a case of Secondary_Cell_Active=6, the CQI or PCI/CQI for each active cell may fill in one slot of HS-DPCCH1 or HS-DPCCH2, and the CQI or PCI/CQI for the deactivated cell may be DTXed or indicated by a CQI DTX codeword in one slot CQI or PCI/CQI field in HS-DPCCH2.

Alternatively, in a case that 3-6 active cells are configured without MIMO, the cells may be remapped to one HS-DPCCH with SF of 128 as shown in FIG. 12. In a case where three cells are configured without MIMO, the three cells may be remapped to one group. The HARQ-ACK information for 3C may be repeated to fill-in all of the HARQ-ACK slots and the CQI may be repeated to fill in the 2-slot CQI field of the HS-DPCCH as shown in FIG. 13, (i.e., the CQI for the serving HS-DSCH cell is encoded and repeated in the first CQI report, and the CQI for the two secondary cells are jointly coded and repeated in the second CQI report).

Alternatively, no remapping of the active cells across the two HS-DPCCHs may be allowed, but the CQI or PCI/CQI for each active cell may be repeated to fill the two-slot CQI field of either HS-DPCCH1 or HS-DPCCH2 sub-frames when the number of active cells associated with that HS-DPCCH is no more than 2. The CQI field may be DTXed or a CQI DTX codeword may be filled in the CQI slot corresponding to the deactivated cell when the number of active cells associated with that HS-DPCCH is more than 2.

Alternatively, no remapping of the active cells across the two HS-DPCCHs may be allowed, and the deactivated secondary cell CQI or PCI/CQI may be DTXed or replaced by a CQI DTX codeword in the corresponding CQI or PCI/CQI slot of either HS-DPCCH1 or HS-DPCCH2.

Alternatively, in a case where 4 cells in HS-DPCCH2 are activated while one or more secondary serving cells in HS-DPCCH1 are deactivated, a cross-channel remapping may not be allowed over two HS-DPCCH.

In another embodiment, the carrier association may be made semi-dynamic by not allowing remapping but allowing repeating the CQI or PCI/CQI for each active cell to fill the two-slot CQI field in either HS-DPCCH1 or HS-DPCCH2 sub-frame when the number of active cells associated with that HS-DPCCH is no more than 2. The CQI slot for the deactivated cell may be DTXed or a CQI DTX codeword may be filled when the number of active cells associated with that HS-DPCCH is more than 2.

In another embodiment, the carrier association may be fixed, (i.e., no remapping of the active cells across the two HS-DPCCHs is allowed), and the CQI or PCI/CQI for the deactivated secondary cells may not be transmitted (i.e., DTXed) or replaced with a CQI DTX codeword in the corresponding CQI or PCI/CQI slot of either HS-DPCCH1 or HS-DPCCH2.

Tables 10 and 11 show example carrier associations for either the HARQ-ACK field or the PCI/CQI field when different numbers of downlink carriers are configured. In the tables, CO denotes either the HARQ-ACK or PCI/CQI field for primary serving cell, C11, C12, . . . , C1n, n=1, 2, 3, denote either the HARQ-ACK or PCI/CQI field for the secondary cells carried on the first HS-DPCCH (HS-DPCCH1), and C21, C22, . . . , C2m, m=1, 2, 3, 4, denote the secondary cells carried on the second HS-DPCCH(HS-DPCCH2).

TABLE 10

| | HARQ- | HARQ- | HARQ- | HARQ- |
|---|---|---|---|---|
| Secondary_Cell_Enabled | ACK1 | ACK2 | ACK3 | ACK4 |
| 0 | C0 | C0 | C0 | C0 |
| 1 | C0 | C0 | C21 | C21 |
| 2 | C0 | C0 | C21/C22 | C21/C22 |
| 3 | C0 | C0 | C21/C22 | C23 |
| 4 | C0 | C0 | C21/C22 | C23/C24 |
| 1 | C0/C11 | C0/C11 | C0/C11 | C0/C11 |
| 2 | C0/C11 | C0/C11 | C21 | C21 |
| 3 | C0/C11 | C0/C11 | C21/C22 | C21/C22 |
| 4 | C0/C11 | C0/C11 | C21/C22 | C23 |
| 5 | C0/C11 | C0/C11 | C21/C22 | C23/C24 |
| 2 | C0/C11 | C12 | C0/C11 | C12 |
| 3 | C0/C11 | C12 | C21 | C21 |
| 4 | C0/C11 | C12 | C21/C22 | C21/C22 |
| 5 | C0/C11 | C12 | C21/C22 | C23 |
| 6 | C0/C11 | C12 | C21/C22 | C23/C24 |
| 3 | C0/C11 | C12/C13 | C0/C11 | C12/C13 |
| 4 | C0/C11 | C12/C13 | C21 | C21 |
| 5 | C0/C11 | C12/C13 | C21/C22 | C21/C22 |
| 6 | C0/C11 | C12/C13 | C21/C22 | C23 |
| 7 | C0/C11 | C12/C13 | C21/C22 | C23/C24 |

TABLE 11

| | HARQ- | HARQ- | HARQ- | HARQ- |
|---|---|---|---|---|
| Secondary_Cell_Enabled | ACK1 | ACK2 | ACK3 | ACK4 |
| 0 | C0 | C0 | C0 | C0 |
| 1 | C0 | C0 | C21 | C21 |
| 2 | C0 | C0 | C21/C22 | C21/C22 |
| 3 | C0 | C0 | C21 | C22/C23 |
| 4 | C0 | C0 | C21/C22 | C23/C24 |
| 1 | C0/C11 | C0/C11 | C0/C11 | C0/C11 |
| 2 | C0/C11 | C0/C11 | C21 | C21 |
| 3 | C0/C11 | C0/C11 | C21/C22 | C21/C22 |
| 4 | C0/C11 | C0/C11 | C21 | C22/C23 |
| 5 | C0/C11 | C0/C11 | C21/C22 | C23/C24 |
| 2 | C0 | C11/C12 | C0/C11 | C12 |
| 3 | C0 | C11/C12 | C21 | C21 |
| 4 | C0 | C11/C12 | C21/C22 | C21/C22 |
| 5 | C0 | C11/C12 | C21 | C22/C23 |
| 6 | C0 | C11/C12 | C21/C22 | C23/C24 |
| 3 | C0/C11 | C12/C13 | C0/C11 | C12/C13 |
| 4 | C0/C11 | C12/C13 | C21 | C21 |
| 5 | C0/C11 | C12/C13 | C21/C22 | C21/C22 |
| 6 | C0/C11 | C12/C13 | C21 | C22/C23 |
| 7 | C0/C11 | C12/C13 | C21/C22 | C23/C24 |

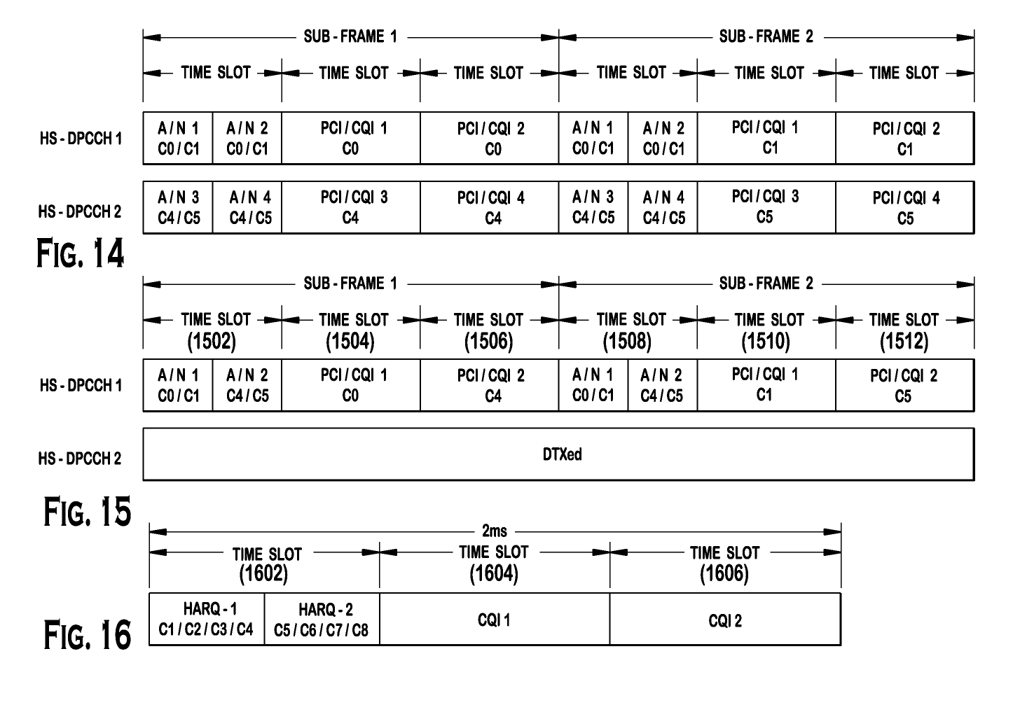

Example implementations of carrier association upon activation/deactivation are described with reference to FIGS. 14 and 15. FIG. 14 shows an example per-channel carrier association upon activation/deactivation for two HS-DPCCHs with SF=128. FIG. 15 shows an example cross-channel carrier association upon activation/deactivation for two HS-DPCCHs with SF=128. In these examples, four cells are activated upon activation/deactivation (i.e., Secondary_Cell_Active=3), which are denoted as C0, C1, C4 and C5.

As shown in FIG. 14, when applying per-channel carrier association for both HARQ-ACK and CQI fields, remapping and repetition are performed independently within HS-DPCCH1 and HS-DPCCH2. As shown in FIG. 15, when applying cross-channel carrier association for both HARQ-ACK and CQI fields, the HARQ-ACK information for the four serving cells (C0, C1, C4, C5) are regrouped/remapped to the HARQ-ACK1 and HARQ-ACK2, which fill in the HARQ-ACK slots 1502, 1508 in HS-DPCCH1. Additionally, the CQI or PCI/CQI for four active cells (C0, C1, C4, C5) are remapped to four slots 1504, 1506, 1510, 1512 of the first and second CQI or PCI/CQI reports of the two HS-DPCCH1 sub-frames while the secondary HS-DPCCH is DTXed.

Compared to per-channel carrier association, upon activation/deactivation for 2 HS-DPCCHs with SF=128 in 8C-HSDPA, cross-channel carrier association may reduce the cubic metric (CM) value as HS-DPCCH2 may be DTXed to save power.

Carrier association upon carrier activation/deactivation or configuration may be defined by dividing the total active carriers into two groups with the constraint that no more than 4 carriers belong to any of the groups, and then mapping all carriers of each group to either HS-DPCCH1 or HS-DPCCH2 by one or any combination of HARQ-ACK and CQI carrier association embodiments described hereinbefore.

For example, in a case of 4 active carriers, 2 carriers may be associated with HS-DPCCH1 and the other 2 carriers may be associated with HS-DPCCH2 as shown in FIG. 14. Alternatively, 4 carriers may be associated with HS-DPCCH1 and 0 carriers may be associated with HS-DPCCH2 (i.e., HS-DPCCH2 may be DTXed) as shown in FIG. 15. Alternatively, 3 carriers may be associated with HS-DPCCH1 and 1 carrier may be associated with HS-DPCCH2. Alternatively, 1 carrier may be associated with HS-DPCCH1 and 3 carriers may be associated with HS-DPCCH2.

For another example, in a case of 6 active carriers, 3 carriers may be associated with HS-DPCCH1 and the other 3 carriers may be associated with HS-DPCCH2. Alternatively, 4 carriers may be associated with HS-DPCCH1 and 2 carriers may be associated with HS-DPCCH2. Alternatively, 2 carriers may be associated with HS-DPCCH1 and 4 carriers may be associated with HS-DPCCH2.

Embodiments for a special case of 6C/5C configuration without MIMO are disclosed hereafter. When six or five serving cells are configured without MIMO being configured in any cells, the number of the transport blocks supported by the uplink feedback is reduced significantly. For 6C/5C without MIMO, one HS-DPCCH with SF=128 may be used with the frame format as shown in FIG. 5 (HS-DPCCH1 only). One HS-DPCCH with SF=128 may carry two sets of HARQ-ACK and CQI messages. The slot format 1 as specified in Table 1 and the corresponding channelization code specified in Table 2 may be applied to the HS-DPCCH frame format for the 6C case.

For HARQ-ACK encoding, the configured serving cells may be divided into two groups. Each group contains three cells (for 5C configuration, the second group may contain 2 cells). For example, the primary serving cell and the first and second serving cells may be placed in group 1, and the third to fifth cells may be placed in group 2.

The ACK/NACK feedback from all the cells in a group may be jointly encoded, as shown in Table 12, where A, N, or D stands for ACK, NACK, and DTX, respectively. For a 5C configuration, a dummy cell is assumed in the second group and has a DTX status corresponding to the location for the last cell. As a result of encoding, two HARQ-ACK codewords are generated.

TABLE 12

| | | | | | | | | | | |
|---|---|---|---|---|---|---|---|---|---|---|
| A/D/D | 1 | 1 | 1 | 1 | 1 | 1 | 1 | 1 | 1 | 1 |
| N/D/D | 0 | 0 | 0 | 0 | 0 | 0 | 0 | 0 | 0 | 0 |
| D/A/D | 1 | 1 | 1 | 1 | 1 | 0 | 0 | 0 | 0 | 0 |
| D/N/D | 0 | 0 | 0 | 0 | 0 | 1 | 1 | 1 | 1 | 1 |
| D/D/A | 1 | 1 | 0 | 0 | 0 | 1 | 1 | 0 | 0 | 0 |
| D/D/N | 0 | 0 | 1 | 1 | 1 | 0 | 0 | 1 | 1 | 1 |
| A/A/D | 1 | 0 | 1 | 0 | 1 | 0 | 1 | 0 | 1 | 0 |
| A/N/D | 1 | 1 | 0 | 0 | 1 | 1 | 0 | 0 | 1 | 1 |
| N/A/D | 0 | 0 | 1 | 1 | 0 | 0 | 1 | 1 | 0 | 0 |
| N/N/D | 0 | 1 | 0 | 1 | 0 | 1 | 0 | 1 | 0 | 1 |
| A/D/A | 1 | 0 | 1 | 1 | 0 | 1 | 1 | 0 | 0 | 1 |
| A/D/N | 0 | 1 | 0 | 1 | 1 | 0 | 1 | 0 | 0 | 1 |
| N/D/A | 0 | 0 | 0 | 1 | 1 | 1 | 1 | 0 | 1 | 0 |
| N/D/N | 1 | 0 | 0 | 1 | 1 | 1 | 0 | 1 | 0 | 0 |
| D/A/A | 0 | 1 | 1 | 1 | 0 | 1 | 0 | 0 | 1 | 0 |
| D/A/N | 1 | 0 | 1 | 0 | 0 | 1 | 0 | 1 | 1 | 0 |
| D/N/A | 0 | 1 | 1 | 0 | 0 | 0 | 1 | 0 | 1 | 1 |
| D/N/N | 0 | 0 | 0 | 0 | 1 | 0 | 1 | 0 | 1 | 1 |
| A/A/A | 1 | 1 | 0 | 1 | 0 | 0 | 1 | 1 | 1 | 0 |
| A/A/N | 0 | 1 | 1 | 0 | 1 | 1 | 1 | 1 | 0 | 0 |
| A/N/A | 1 | 0 | 0 | 1 | 0 | 0 | 0 | 0 | 1 | 1 |
| A/N/N | 0 | 0 | 1 | 0 | 1 | 1 | 0 | 0 | 0 | 1 |
| N/A/A | 1 | 1 | 1 | 0 | 0 | 0 | 0 | 1 | 0 | 1 |
| N/A/N | 0 | 1 | 0 | 0 | 1 | 0 | 0 | 1 | 1 | 0 |
| N/N/A | 1 | 0 | 0 | 0 | 1 | 0 | 1 | 1 | 0 | 1 |
| N/N/N | 1 | 1 | 1 | 1 | 0 | 1 | 0 | 1 | 0 | 0 |

PRE/POST

| | | | | | | | | | | | | | | | | | | | | | |
|---|---|---|---|---|---|---|---|---|---|---|---|---|---|---|---|---|---|---|---|---|---|
| PRE | 0 | 0 | 1 | 0 | 0 | 1 | 0 | 0 | 1 | 0 | POST | 0 | 1 | 0 | 0 | 1 | 0 | 0 | 1 | 0 | 0 |

In Table 12, the D/D/D state is not included because it is implied by no transmission over the HS-DPCCH. For 6C/5C configurations, when all the serving cells in a group have DTX status, a half slot transmission may occur.

To avoid the half-slot transmission, a DTX codeword may be introduced in the above table. One of the codewords in Table 13 may be used as the DTX codeword. Any of the selections will give a minimum distance of 3 to other codewords in the codebook specified in Table 12, and a minimum distance of 4 to the key codewords (A/A/A, A/A/N, A/N/A, N/A/A).

TABLE 13

| | | | | | | | | | | |
|---|---|---|---|---|---|---|---|---|---|---|
| codeword 1 | 0 | 0 | 0 | 1 | 0 | 1 | 0 | 1 | 1 | 0 |
| codeword 2 | 0 | 0 | 0 | 1 | 1 | 1 | 1 | 1 | 0 | 1 |
| codeword 3 | 0 | 1 | 0 | 1 | 0 | 1 | 1 | 0 | 1 | 1 |
| codeword 4 | 0 | 1 | 0 | 1 | 1 | 1 | 0 | 0 | 0 | 0 |
| codeword 5 | 0 | 1 | 1 | 1 | 1 | 0 | 1 | 0 | 1 | 0 |
| codeword 6 | 1 | 0 | 0 | 0 | 1 | 1 | 1 | 1 | 1 | 0 |
| codeword 7 | 1 | 0 | 0 | 1 | 1 | 0 | 1 | 0 | 0 | 0 |
| codeword 8 | 1 | 0 | 1 | 1 | 1 | 1 | 0 | 0 | 1 | 0 |

Alternatively, the DTX codeword may be selected from Table 14, which will provide a minimum distance>4 to the key codewords (A/A/A, A/A/N, A/N/A, N/A/A) and the number of the codewords that have a distance of 2 to a selected DTX codeword is reduced.

TABLE 14

| | | | | | | | | | | |
|---|---|---|---|---|---|---|---|---|---|---|
| codeword 1 | 0 | 0 | 0 | 0 | 0 | 1 | 1 | 0 | 0 | 1 |
| codeword 2 | 0 | 0 | 0 | 0 | 1 | 1 | 0 | 1 | 1 | 1 |
| codeword 3 | 0 | 0 | 0 | 1 | 0 | 1 | 1 | 0 | 0 | 0 |
| codeword 4 | 0 | 0 | 1 | 1 | 0 | 1 | 1 | 1 | 1 | 1 |
| codeword 5 | 0 | 0 | 1 | 1 | 1 | 0 | 0 | 0 | 0 | 0 |
| codeword 6 | 0 | 0 | 1 | 1 | 1 | 0 | 1 | 0 | 0 | 1 |
| codeword 7 | 0 | 0 | 1 | 1 | 1 | 1 | 1 | 0 | 1 | 1 |
| codeword 8 | 0 | 1 | 0 | 1 | 1 | 1 | 0 | 1 | 1 | 1 |
| codeword 9 | 0 | 1 | 1 | 1 | 1 | 1 | 0 | 0 | 1 | 1 |
| codeword 10 | 1 | 0 | 0 | 0 | 1 | 1 | 0 | 0 | 0 | 0 |
| codeword 11 | 1 | 0 | 0 | 0 | 1 | 1 | 1 | 0 | 0 | 1 |
| codeword 12 | 1 | 0 | 1 | 0 | 1 | 1 | 1 | 0 | 1 | 1 |
| codeword 13 | 1 | 1 | 0 | 1 | 1 | 1 | 1 | 0 | 0 | 1 |

Alternatively, the DTX codeword may be selected from Table 15, which will provide a minimum distance of 3 to other codewords in the codebook.

TABLE 15

| | | | | | | | | | | |
|---|---|---|---|---|---|---|---|---|---|---|
| codeword 1 | 0 | 0 | 0 | 1 | 0 | 0 | 0 | 1 | 1 | 0 |
| codeword 2 | 0 | 0 | 1 | 1 | 0 | 0 | 0 | 0 | 0 | 1 |
| codeword 3 | 0 | 0 | 1 | 1 | 1 | 1 | 1 | 1 | 0 | 1 |
| codeword 4 | 0 | 1 | 0 | 0 | 0 | 0 | 1 | 1 | 0 | 1 |
| codeword 5 | 0 | 1 | 1 | 0 | 0 | 1 | 0 | 1 | 1 | 1 |
| codeword 6 | 0 | 1 | 1 | 0 | 1 | 1 | 0 | 1 | 1 | 1 |
| codeword 7 | 0 | 1 | 1 | 1 | 0 | 0 | 0 | 0 | 0 | 1 |
| codeword 8 | 0 | 1 | 1 | 1 | 1 | 0 | 1 | 1 | 1 | 0 |
| codeword 9 | 1 | 0 | 0 | 0 | 0 | 1 | 0 | 0 | 0 | 1 |
| codeword 10 | 1 | 0 | 0 | 0 | 0 | 1 | 0 | 1 | 0 | 1 |
| codeword 11 | 1 | 0 | 0 | 1 | 0 | 0 | 1 | 0 | 0 | 0 |
| codeword 12 | 1 | 0 | 1 | 0 | 0 | 0 | 1 | 1 | 1 | 1 |
| codeword 13 | 1 | 0 | 1 | 0 | 1 | 0 | 0 | 1 | 0 | 0 |
| codeword 14 | 1 | 0 | 1 | 1 | 0 | 0 | 1 | 1 | 1 | 1 |
| codeword 15 | 1 | 0 | 1 | 1 | 1 | 1 | 0 | 0 | 1 | 1 |
| codeword 16 | 1 | 1 | 0 | 0 | 0 | 0 | 0 | 0 | 1 | 0 |
| codeword 17 | 1 | 1 | 0 | 0 | 1 | 1 | 1 | 1 | 1 | 0 |
| codeword 18 | 1 | 1 | 0 | 1 | 0 | 1 | 1 | 0 | 1 | 1 |
| codeword 19 | 1 | 1 | 0 | 1 | 1 | 0 | 0 | 1 | 0 | 1 |
| codeword 20 | 1 | 1 | 0 | 1 | 1 | 0 | 0 | 1 | 1 | 1 |
| codeword 21 | 1 | 1 | 1 | 0 | 0 | 0 | 0 | 0 | 1 | 0 |
| codeword 22 | 1 | 1 | 1 | 0 | 1 | 0 | 1 | 0 | 0 | 1 |
| codeword 23 | 1 | 1 | 1 | 0 | 1 | 1 | 1 | 0 | 0 | 1 |

Alternatively, the PRE or POST codewords in Table 12 may be used as the DTX codeword.

When some of the secondary serving cells are deactivated in 6C/5C cases, there is no need to report the HARQ-ACK information associated with the inactive cells. The carrier association to the HARQ-ACK messages may be remapped to improve the transmission reliability or power efficiency of the HS-DPCCH.

If all the serving cells in a group are deactivated, a half-slot transmission may occur. To avoid a half-slot transmission, the serving cells may be remapped and regrouped once the activation/deactivation of cells occurs. The ACK/NACK information in a group is then jointly encoded. If one HARQ-ACK message is left empty because of not enough active cells, the other HARQ-ACK message may be repeated in an HARQ-ACK slot.

Denote a serving HS-DSCH cell as C0 and all active secondary serving cells as C1, C2, . . . , Cn, n=Secondary_Cell_Active. Tables 16 and 17 show example carrier association for 6C/5C cases. The rows in Tables 16 and 17 may be combined in any arrangement to form a new carrier association table.

TABLE 16

| | HARQ- | HARQ- |
|---|---|---|
| Secondary_Cell_Active | ACK1 | ACK2 |
| 0 | CO | C0 |
| 1 | C0/C1 | C0/C1 |
| 2 | C0/C1/C2 | C0/C1/C2 |
| 3 | C0/C1/C2 | C3 |
| 4 | C0/C1/C2 | C3/C4 |
| 5 | C0/C1/C2 | C3/C4/C5 |

TABLE 17

| Secondary_{—} | HARQ- | HARQ- |
|---|---|---|
| Cell_Active | ACK1 | ACK2 |
| 0 | C0 | C0 |
| 1 | C0/C1 | C0/C1 |
| 2 | C0/C1/C2 | C0/C1/C2 |
| 3 | C0 | C1/C2/C3 |
| 4 | C0/C1 | C2/C3/C4 |
| 5 | C0/C1/C2 | C3/C4/C5 |

Alternatively, the carrier association for the configured secondary serving cells may remain the same, (i.e., no remapping is performed when activation/deactivation of cells occurs), but when all the serving cells in the second group are deactivated, HARQ-ACK1 may be repeated in HARQ-ACK2.

With the slot format 1 of SF=128 for HS-DPCCH, two CQI messages are available in a sub-frame as shown in FIG. 11. For CQI reporting in 6C/5C cases, the CQIs may be paired and/or jointly encoded and then transmitted in a time division multiplexing (TDM) fashion over different sub-frames. The minimum CQI feedback cycle may be made equal to 4 ms. Alternatively, the CQIs for each serving cell may be independently encoded and transmitted in a TDM fashion, which will result in a longer CQI feedback cycle.

Alternatively, the number of PCI/CQI messages that need to be transmitted may be reduced by sending a single PCI/CQI message for each pair of carriers. This has an effect of reducing the number of PCI/CQI messages by half. The single message for each pair may include an average PCI/CQI value for the paired carriers, or one PCI/CQI value and a delta value of the difference between the two PCI/CQI values, or a jointly coded value.

The secondary serving cells for the 6C/5C cases may be activated or deactivated dynamically via L1 signaling, (i.e., high speed shared control channel (HS-SCCH) order). Multiple secondary serving cells may activated and deactivated simultaneously by one HS-SCCH order. Table 18 shows an example activation and deactivation state table for 6C/5C cases. Table 19 shows an example bit assignment for an HS-SCCH order that is mapped to the activation and deactivation states in Table 18. It should be noted that Tables 18 and 19 are provided as an example, and other forms of the bit assignment are also possible.

TABLE 18

| | Activation Status of Secondary Serving HS-DSCH cells and | | | | | |
|---|---|---|---|---|---|---|
| | Secondary Uplink Frequency | | | | | |
| | A = Activate; D = De-activate | | | | | |
| | 1^{st} | 2nd | 3rd | | | |
| | second- | second- | second- | 4th | 5th | |
| | ary | ary | ary | secondary | secondary | secondary |
| state | serving | serving | serving | serving | serving | uplink |
| number | cell | cell | cell | cell | cell | frequency |
| 1 | D | D | D | D | D | D |
| 2 | A | D | D | D | D | D |
| 3 | A | D | D | D | D | A |
| 4 | D | A | D | D | D | D |
| 5 | A | A | D | D | D | D |
| 6 | A | A | D | D | D | A |
| 7 | D | D | A | D | D | D |
| 8 | A | D | A | D | D | D |
| 9 | A | D | A | D | D | A |
| 10 | D | A | A | D | D | D |
| 11 | A | A | A | D | D | D |
| 12 | A | A | A | D | D | A |
| 13 | D | D | D | A | D | D |
| 14 | A | D | D | A | D | D |
| 15 | A | D | D | A | D | A |
| 16 | D | A | D | A | D | D |
| 17 | A | A | D | A | D | D |
| 18 | A | A | D | A | D | A |
| 19 | D | D | A | A | D | D |
| 20 | A | D | A | A | D | D |
| 21 | A | D | A | A | D | A |
| 22 | D | A | A | A | D | D |
| 23 | A | A | A | A | D | D |
| 24 | A | A | A | A | D | A |
| 25 | D | D | D | D | A | D |
| 26 | A | D | D | D | A | D |
| 27 | A | D | D | D | A | A |
| 28 | D | A | D | D | A | D |
| 29 | A | A | D | D | A | D |
| 30 | A | A | D | D | A | A |
| 31 | D | D | A | D | A | D |
| 32 | A | D | A | D | A | D |
| 33 | A | D | A | D | A | A |
| 34 | D | A | A | D | A | D |
| 35 | A | A | A | D | A | D |
| 36 | A | A | A | D | A | A |
| 37 | D | D | D | A | A | D |
| 38 | A | D | D | A | A | D |
| 39 | A | D | D | A | A | A |
| 40 | D | A | D | A | A | D |
| 41 | A | A | D | A | A | D |
| 42 | A | A | D | A | A | A |
| 43 | D | D | A | A | A | D |
| 44 | A | D | A | A | A | D |
| 45 | A | D | A | A | A | A |
| 46 | D | A | A | A | A | D |
| 47 | A | A | A | A | A | D |
| 48 | A | A | A | A | A | A |

TABLE 19

| Order Type | Order Mapping | | | state |
|---|---|---|---|---|
| (xodt, 1, xodt, 2, xodt, 3 ) | Xord, 1 | Xord, 2 | Xord, 3 | number |
| 001 | 0 | 0 | 0 | 1 |
| | 0 | 0 | 1 | 2 |
| | 0 | 1 | 0 | 3 |
| | 0 | 1 | 1 | 4 |
| | 1 | 0 | 0 | 5 |
| | 1 | 0 | 1 | 6 |
| | 1 | 1 | 0 | 7 |
| | 1 | 1 | 1 | 8 |
| 010 | 0 | 0 | 0 | 9 |
| | 0 | 0 | 1 | 10 |
| | 0 | 1 | 0 | 11 |
| | 0 | 1 | 1 | 12 |
| | 1 | 0 | 0 | 13 |
| | 1 | 0 | 1 | 14 |
| | 1 | 1 | 0 | 15 |
| | 1 | 1 | 1 | 16 |
| 011 | 0 | 0 | 0 | 17 |
| | 0 | 0 | 1 | 18 |
| | 0 | 1 | 0 | 19 |
| | 0 | 1 | 1 | 20 |
| | 1 | 0 | 0 | 21 |
| | 1 | 0 | 1 | 22 |
| | 1 | 1 | 0 | 23 |
| | 1 | 1 | 1 | 24 |
| 100 | 0 | 0 | 0 | 25 |
| | 0 | 0 | 1 | 26 |
| | 0 | 1 | 0 | 27 |
| | 0 | 1 | 1 | 28 |
| | 1 | 0 | 0 | 29 |
| | 1 | 0 | 1 | 30 |
| | 1 | 1 | 0 | 31 |
| | 1 | 1 | 1 | 32 |
| 101 | 0 | 0 | 0 | 33 |
| | 0 | 0 | 1 | 34 |
| | 0 | 1 | 0 | 35 |
| | 0 | 1 | 1 | 36 |
| | 1 | 0 | 0 | 37 |
| | 1 | 0 | 1 | 38 |
| | 1 | 1 | 0 | 39 |
| | 1 | 1 | 1 | 40 |
| 110 | 0 | 0 | 0 | 41 |
| | 0 | 0 | 1 | 42 |
| | 0 | 1 | 0 | 43 |
| | 0 | 1 | 1 | 44 |
| | 1 | 0 | 0 | 45 |
| | 1 | 0 | 1 | 46 |
| | 1 | 1 | 0 | 47 |
| | 1 | 1 | 1 | 48 |

Another special case is the 8 or 7 carriers configuration (8C/7C cases) without MIMO being configured in any cells. For the special case of 8C-HSDPA, where no MIMO is configured in any cells, the total number of transport block to be supported is 8. FIG. 16 shows an example HS-DPCCH frame format with SF=128 for 8C-HSDPA 8C/7C special cases. The ACK/NACK messages for 4 carriers may be jointly encoded. HARQ-1 and HARQ-2 for four cells (or four cells and three cells), respectively, are transmitted on a first time slot 1602, and CQI reports are transmitted on second and third time slots 1604, 1606. A codebook for the HARQ-ACK feedback for 8C/7C without MIMO needs to accommodate 80 (3⁴−1=80) composite HARQ-ACK states for four serving cells that are jointly encoded, excluding PRE and POST codewords. The composite ACK/NACK states of the four cells are listed in Table 20.

TABLE 20

| | | | | | | | |
|---|---|---|---|---|---|---|---|
| D/D/D/A | D/A/D/N | D/N/A/D | A/D/A/A | A/A/A/N | A/N/N/D | N/D/N/A | N/A/N/N |
| D/D/D/N | D/A/A/D | D/N/A/A | A/D/A/N | A/A/N/D | A/N/N/A | N/D/N/N | N/N/D/D |
| D/D/A/D | D/A/A/A | D/N/A/N | A/D/N/D | A/A/N/A | A/N/N/N | N/A/D/D | N/N/D/A |
| D/D/A/A | D/A/A/N | D/N/N/D | A/D/N/A | A/A/N/N | N/D/D/D | N/A/D/A | N/N/D/N |
| D/D/A/N | D/A/N/D | D/N/N/A | A/D/N/N | A/N/D/D | N/D/D/A | N/A/D/N | N/N/A/D |
| D/D/N/D | D/A/N/A | D/N/N/N | A/A/D/D | A/N/D/A | N/D/D/N | N/A/A/D | N/N/A/A |
| D/D/N/A | D/A/N/N | A/D/D/D | A/A/D/A | A/N/D/N | N/D/A/D | N/A/A/A | N/N/A/N |
| D/D/N/N | D/N/D/D | A/D/D/A | A/A/D/N | A/N/A/D | N/D/A/A | N/A/A/N | N/N/N/D |
| D/A/D/D | D/N/D/A | A/D/D/N | A/A/A/D | A/N/A/A | N/D/A/N | N/A/N/D | N/N/N/A |
| D/A/D/A | D/N/D/N | A/D/A/D | A/A/A/A | A/N/A/N | N/D/N/D | N/A/N/A | N/N/N/N |

In order to reduce the number of codewords, some states in Table 20 may be consolidated. In one embodiment, the downlink control signaling procedure may be modified such that a WTRU is informed about the transmission status from the serving cells, and some of the ACK/NACK states would never occur. This may be achieved by pairing the two carriers in downlink physical channels that report the transport block sizes of the HS-DPSCH.

When both serving cells are transmitting data to a WTRU configured with the 8C/7C special mode in a sub-frame, a type 3 HS-SCCH may be used for the control signaling which is capable of reporting downlink control information (such as transport block size, modulation parameters, etc.) to a WTRU for two data streams. The two sets of control information may be associated with the downlink transmissions from the two cells. Therefore, only one HS-SCCH may be sent on either of the carriers. Alternatively, the HS-SCCH may be sent on both carriers to improve the reliability of reception. When one cell is transmitting data to the WTRU among the pair of cells in a sub-frame, type 1 HS-SCCH may be transmitted on the carrier that is transmitting the HS-PDSCH. Thus, if a type 1 HS-SCCH is received at the WTRU in a sub-frame, it implies that the other serving cell in the pair is DTXed. With this HS-SCCH configuration, the ACK/NACK states for the two cells may be reduced as shown in Table 21.

TABLE 21

D/D → D
D/A and A/D → A
D/N and N/D → N
A/A → A/A
A/N → A/N
N/A → N/A
N/N → N/N

Table 22 shows an example codebook for the 8C/7C special cases after applying the consolidation.

TABLE 22

| | | | | | | | | | | | | | | | | | | | | | |
|---|---|---|---|---|---|---|---|---|---|---|---|---|---|---|---|---|---|---|---|---|---|
| A/D | 1 | 1 | 1 | 1 | 1 | 1 | 1 | 1 | 1 | 1 | A/A/A | 0 | 1 | 1 | 0 | 0 | 0 | 0 | 1 | 0 | 0 |
| N/D | 0 | 0 | 0 | 0 | 0 | 0 | 0 | 0 | 0 | 0 | A/A/N | 1 | 1 | 1 | 0 | 0 | 1 | 1 | 0 | 1 | 0 |
| A/A/D | 1 | 0 | 1 | 0 | 1 | 1 | 1 | 1 | 0 | 1 | A/N/A | 1 | 0 | 1 | 1 | 1 | 0 | 0 | 1 | 1 | 0 |
| A/N/D | 1 | 1 | 0 | 1 | 0 | 1 | 0 | 1 | 1 | 1 | A/N/N | 0 | 0 | 1 | 1 | 0 | 1 | 0 | 0 | 0 | 1 |
| N/A/D | 0 | 1 | 1 | 1 | 1 | 0 | 1 | 0 | 1 | 1 | N/A/A | 0 | 1 | 0 | 1 | 1 | 1 | 1 | 1 | 0 | 0 |
| N/N/D | 1 | 0 | 0 | 1 | 0 | 0 | 1 | 0 | 0 | 0 | N/A/N | 1 | 1 | 0 | 0 | 1 | 0 | 0 | 0 | 0 | 1 |
| D/A | 0 | 0 | 0 | 0 | 0 | 0 | 1 | 1 | 1 | 1 | N/N/A | 0 | 0 | 0 | 0 | 1 | 1 | 0 | 0 | 1 | 0 |
| D/N | 1 | 1 | 1 | 1 | 1 | 1 | 0 | 0 | 0 | 0 | N/N/N | 0 | 1 | 0 | 0 | 0 | 1 | 1 | 0 | 0 | 1 |
| D/A/A | 1 | 0 | 0 | 0 | 1 | 0 | 0 | 0 | 1 | 1 | A/A/AA | 0 | 1 | 1 | 0 | 1 | 1 | 0 | 1 | 1 | 1 |
| D/A/N | 0 | 1 | 0 | 0 | 0 | 0 | 1 | 1 | 0 | 1 | A/A/A/N | 1 | 0 | 1 | 1 | 0 | 0 | 1 | 1 | 1 | 1 |
| D/N/A | 0 | 0 | 0 | 1 | 1 | 1 | 1 | 1 | 1 | 0 | A/A/N/A | 1 | 1 | 0 | 1 | 1 | 1 | 1 | 0 | 0 | 1 |
| D/N/N | 1 | 1 | 1 | 1 | 1 | 0 | 0 | 1 | 0 | 0 | A/A/N/N | 0 | 1 | 1 | 1 | 0 | 1 | 1 | 1 | 0 | 0 |
| A/A | 1 | 1 | 0 | 1 | 0 | 0 | 0 | 0 | 1 | 1 | A/N/A/A | 0 | 0 | 0 | 1 | 1 | 0 | 0 | 1 | 0 | 1 |
| A/N | 0 | 0 | 1 | 1 | 1 | 0 | 1 | 0 | 0 | 1 | A/N/A/N | 1 | 1 | 1 | 0 | 0 | 0 | 0 | 0 | 0 | 1 |
| N/A | 1 | 0 | 0 | 1 | 0 | 1 | 1 | 1 | 0 | 0 | A/N/N/A | 1 | 0 | 0 | 0 | 0 | 1 | 0 | 1 | 0 | 0 |
| N/N | 0 | 1 | 1 | 0 | 0 | 1 | 0 | 1 | 0 | 1 | A/N/N/N | 0 | 0 | 1 | 1 | 0 | 1 | 0 | 0 | 0 | 1 |
| A/A/A | 1 | 0 | 1 | 0 | 0 | 1 | 1 | 0 | 0 | 0 | N/A/A/A | 1 | 1 | 0 | 0 | 1 | 0 | 1 | 1 | 1 | 0 |
| A/A/N | 1 | 0 | 0 | 1 | 0 | 1 | 0 | 1 | 0 | 1 | N/A/A/N | 0 | 0 | 1 | 0 | 1 | 0 | 1 | 0 | 0 | 0 |
| A/N/A | 0 | 0 | 1 | 1 | 1 | 0 | 1 | 0 | 0 | 1 | N/A/N/A | 1 | 0 | 1 | 1 | 1 | 1 | 0 | 0 | 1 | 0 |
| A/N/N | 0 | 1 | 1 | 1 | 0 | 1 | 0 | 0 | 1 | 1 | N/A/N/N | 1 | 1 | 1 | 0 | 0 | 1 | 1 | 0 | 1 | 0 |
| N/A/A | 1 | 1 | 0 | 1 | 0 | 0 | 1 | 0 | 1 | 0 | N/N/A/A | 0 | 1 | 0 | 1 | 0 | 0 | 0 | 0 | 1 | 0 |
| N/A/N | 1 | 1 | 0 | 0 | 0 | 1 | 0 | 1 | 1 | 0 | N/N/A/N | 0 | 0 | 1 | 0 | 0 | 0 | 0 | 1 | 1 | 0 |
| N/N/A | 0 | 1 | 1 | 0 | 1 | 0 | 1 | 0 | 1 | 0 | N/N/N/A | 0 | 1 | 0 | 0 | 1 | 1 | 0 | 0 | 0 | 0 |
| N/N/N | 0 | 0 | 1 | 0 | 1 | 1 | 0 | 1 | 0 | 1 | N/N/N/N | 0 | 0 | 0 | 0 | 0 | 1 | 1 | 0 | 1 | 1 |

The above embodiment may be extended to other cases, such as 7C with MIMO configured in one serving cell, 6C with MIMO configured in two serving cells, or 5C with MIMO configured in three serving cells, where the serving cells configured in MIMO mode do not need to be paired in the HS-SCCH transmission.

This embodiment may also be applied to the 6C/5C special cases described hereinbefore where the ACK/NACK status for non-configured serving cells are denoted by DTX.

In another embodiment, the codebook reduction may be achieved by introducing the concept of restricted downlink transmission. For example, the configured serving cells may be paired and the HS-PDSCH transmissions may be allowed at a sub-frame if both serving cells are scheduled for data transmission. The ACK/NACK encoding as specified in Table 22 may be then applied.

In another embodiment, a grouped DTX reporting may be introduced for the paired serving cells as shown in Table 23. The ACK/NACK encoding as specified in Table 22 may be then applied.

TABLE 23

D/D
D/N → D
N/D
D/A → D/A
A/D → A/D
A/A → A/A
A/N → A/N
N/A → N/A
N/N → N/N

The amount of the feedback information for 8C-HSDPA may be reduced by bundling MIMO steams or carriers for a grouped reporting. The ACK/NACK feedback for the general cases with MIMO configured may be simplified by grouping ACK/NACK reporting for the primary and secondary streams. Table 24 shows an example ACK/NACK grouping. With this scheme, the codebook in Table 22 may be used for the 8C general cases as well.

TABLE 24

| Actual HARQ-ACK states | Reported HARQ-ACK states |
|---|---|
| A | A |
| N | N |
| AA | A |
| NA | N |
| AN | N |
| NN | N |

Alternatively or additionally, the serving cells may be paired for the grouped HARQ-ACK reporting. For example, the third serving cell and the seventh serving cell may be paired and the HARQ-ACK states for the two cells may be grouped as in Table 24 for either the primary stream or the secondary stream. With this embodiment, the slot format with SF=128 may be used for the 8C general cases.

A CQI or PCI/CQI may be reported to network in a TDM fashion with a longer feedback cycle. Alternatively, the CQIs (CQIs/PCIs) of a pair of serving cells may be combined into one set of feedback, for example, by averaging the two CQIs, selecting the worst CQI corresponding to the worst channel or carrier, or selecting the best CQI corresponding to the best channel or carrier.

Alternatively, the feedback reported for one cell may be used as the basis for the feedback reported for one or more other cells. A WTRU may report the combination of N base CQI(s) and up to N corresponding sets of delta (or differential) CQI(s) to the network. A base CQI may be the medium, average, best (i.e., corresponding to the best channel/carrier), or worst of all CQIs, and the delta (or differential) CQI is defined as the difference with respect to the base CQI. The base CQI may be the average or best CQI of all carriers within one frequency band, and the delta CQI may be the offset CQI of each carrier within the frequency band with respect to the base CQI. The base CQI may be the actual CQI of a specific cell.

N is an integer value equal to or greater than 1, which may be pre-defined or signaled by a higher layer depending on the carrier configuration such as the number of carriers configured within a frequency band, or MIMO configuration, carrier activation/deactivation status, or other factors affecting the feedback CQI payload. For example, if all carriers are configured across two frequency bands, N may be selected as the total number of bands that all configured carriers are crossing, (i.e., N=2 in this example).

The number of delta CQIs may depend on the number of configured carriers paired with the base CQI, or the number of activated carriers paired with the base CQI. The pairing of the base CQI and the delta CQI may be pre-defined or signaled by a higher layer based on predetermined rules.

The base CQI and the delta CQI may be reported in a frequency division multiplexing (FDM) fashion. Alternatively, the base CQI and the delta CQI may be reported in a TDM fashion, (i.e., one base CQI is reported in transmit time interval (TTI) k, and the delta CQI with respect to the based CQI is reported in a subsequent TTI. Alternatively, the base CQI and the delta CQI may be reported in a mix of FDM and TDM fashion.

Embodiments for HS-DPCCH power offset setting in 8C-HSDPA are described hereafter.

In 8C-HSDPA, different HS-DPCCH slot formats may be used based on the number of carriers configured or activated at the WTRU. The HARQ-ACK power offset may be dependent on the number of carriers that have MIMO configured. The probability of detection error and misdetection for a specific false alarm target, (e.g., 1% or 10%), may be used as the metric to determine the HARQ-ACK power offset on a per stream basis denoted as Pe_str, or on a per codeword basis denoted as Pe_cw, or RLC retransmission probability denoted as Pr_LC. The performance target for Pe_str, Pe_cw, and Pr_LC may be respectively 1%, 1% and 0.01% when designing the power offset rules for HARQ-ACK. Given different configurations such as the number of carriers activated and the number of carriers that have MIMO configured, the maximum power offset required to maintain the performance target for the codebooks may be obtained through simulation, and various power offset setting schemes for HARQ-ACK field, (i.e., HS-DPCCH slots carrying HARQ-ACK), when Secondary_Cell_Active is bigger than 3, (i.e., for 8C-HSDPA), are disclosed below.

For the general case where a spreading factor of 64 is used, the HARQ-ACK power offset setting may be defined as in Table 25. In general, higher power offset is assumed for almost every case of SF=64 to compensate the spreading gain loss due to use of a smaller spreading factor. In tables below, the values for Δ_{ACK}, Δ_{NACK} and Δ_{CQI} are set by higher layers and are translated to the quantized amplitude ratios Aₕₛ.

TABLE 25

| | | Aₕₛ equals the quantized amplitude | | |
|---|---|---|---|---|
| | | ratio translated from | | |
| | | Composite HARQ-ACK message(s) | | |
| | | sent in one time slot | | |
| | | contains at | contains at | contains both |
| | | least one | least one | ACK and NACK |
| Secondary_{—} | | ACK but no | NACK but | or is a PRE or is |
| Cell_Active | Condition | NACK | no ACK | a POST |
| 1 | | Δ_{ACK} + 1 | Δ_{NACK} + 1 | MAX(Δ_{ACK} + 1, |
| | | | | Δ_{NACK} + 1) |
| 2 | Secondary_Cell_Enabled | Δ_{ACK} + 1 | Δ_{NACK} + 1 | MAX(Δ_{ACK} + 1, |
| | is 2 and MIMO is not | | | Δ_{NACK} + 1) |
| | configured in any cell | | | |
| | Otherwise | Δ_{ACK} + 2 | Δ_{NACK} + 2 | MAX(Δ_{ACK} + 2, |
| | | | | Δ_{NACK} + 2) |
| 3 | | Δ_{ACK} + 2 | Δ_{NACK} + 2 | MAX(Δ_{ACK} + 2, |
| | | | | Δ_{NACK} + 2) |
| 4 | | Δ_{ACK} + 3 | Δ_{NACK} + 3 | MAX(Δ_{ACK} + 3, |
| | | | | Δ_{NACK} + 3) |
| 5 | | Δ_{ACK} + 3 | Δ_{NACK} + 3 | MAX(Δ_{ACK} + 3, |
| | | | | Δ_{NACK} + 3) |
| 6 | | Δ_{ACK} + 3 | Δ_{NACK} + 3 | MAX(Δ_{ACK} + 3, |
| | | | | Δ_{NACK} + 3) |
| 7 | | Δ_{ACK} + 3 | Δ_{NACK} + 3 | MAX(Δ_{ACK} + 3, |
| | | | | Δ_{NACK} + 3) |

Alternatively, to guarantee the HARQ-ACK performance for all possible cases including the worst case which requires the most power, the HARQ-ACK power offset setting for all cases when Secondary_Cell_Active>3 with SF=64 may be defined as in Table 26.

TABLE 26

| | | Aₕₛ equals the quantized amplitude | | |
|---|---|---|---|---|
| | | ratio translated from | | |
| | | Composite HARQ-ACK message(s) | | |
| | | sent in one time slot | | |
| | | contains at | contains at | contains both |
| | | least one | least one | ACK and NACK |
| Secondary_{—} | | ACK but no | NACK but | or is a PRE or |
| Cell_Active | Condition | NACK | no ACK | is a POST |
| 1 | | Δ_{ACK} + 1 | Δ_{NACK} + 1 | MAX(Δ_{ACK} + 1, |
| | | | | Δ_{NACK} + 1) |
| 2 | Secondary_Cell_Enabled | Δ_{ACK} + 1 | Δ_{NACK} + 1 | MAX(Δ_{ACK} + 1, |
| | is 2 and MIMO is not | | | Δ_{NACK} + 1) |
| | configured in any cell | | | |
| | Otherwise | Δ_{ACK} + 2 | Δ_{NACK} + 2 | MAX(Δ_{ACK} + 2, |
| | | | | Δ_{NACK} + 2) |
| 3 | | Δ_{ACK} + 2 | Δ_{NACK} + 2 | MAX(Δ_{ACK} + 2, |
| | | | | Δ_{NACK} + 2) |
| 4 | | Δ_{ACK} + 4 | Δ_{NACK} + 4 | MAX(Δ_{ACK} + 4, |
| | | | | Δ_{NACK} + 4) |
| 5 | | Δ_{ACK} + 4 | Δ_{NACK} + 4 | MAX(Δ_{ACK} + 4, |
| | | | | Δ_{NACK} + 4) |
| 6 | | Δ_{ACK} + 4 | Δ_{NACK} + 4 | MAX(Δ_{ACK} + 4, |
| | | | | Δ_{NACK} + 4) |
| 7 | | Δ_{ACK} + 4 | Δ_{NACK} + 4 | MAX(Δ_{ACK} + 4, |
| | | | | Δ_{NACK} + 4) |

For the special case of 6C/5C without MIMO when SF=128 is used, the HARQ-ACK power offset may be set less conservatively so that the interference level may be decreased. The power offset may be reduced by 1 as compared to the corresponding configuration with the general case where SF=64 is used. For example, the HARQ-ACK power offset setting when Secondary_Cell_Active=4 or 5 without MIMO and SF=128 is used may be defined as in Table 27. For another example, the HARQ-ACK power offset setting when Secondary_Cell_Active=4 or 5 without MIMO when SF=128 is used may be defined as in Table 28.

TABLE 27

| | | Aₕₛ equals the quantized amplitude | | |
|---|---|---|---|---|
| | | ratio translated from | | |
| | | Composite HARQ-ACK message(s) | | |
| | | sent in one time slot | | |
| | | contains at | contains at | contains both |
| | | least one | least one | ACK and NACK |
| Secondary_{—} | | ACK but no | NACK but | or is a PRE or |
| Cell_Active | Condition | NACK | no ACK | is a POST |
| 4 | Secondary_Cell_Enabled | Δ_{ACK} + 2 | Δ_{NACK} + 2 | MAX(Δ_{ACK} + 2, |
| | is 4 and MIMO is not | | | Δ_{NACK} + 2) |
| | configured in any cell | | | |
| | Otherwise | Δ_{ACK} + 3 | Δ_{NACK} + 3 | MAX(Δ_{ACK} + 3, |
| | | | | Δ_{NACK} + 3) |
| 5 | Secondary_Cell_Enabled | Δ_{ACK} + 2 | Δ_{NACK} + 2 | MAX(Δ_{ACK} + 2, |
| | is 5 and MIMO is not | | | Δ_{NACK} + 2) |
| | configured in any cell | | | |
| | Otherwise | Δ_{ACK} + 3 | Δ_{NACK} + 3 | MAX(Δ_{ACK} + 3, |
| | | | | Δ_{NACK} + 3) |

TABLE 28

| | | Aₕₛ equals the quantized amplitude | | |
|---|---|---|---|---|
| | | ratio translated from | | |
| | | Composite HARQ-ACK message(s) | | |
| | | sent in one time slot | | |
| | | contains at | contains at | contains both |
| | | least one | least one | ACK and NACK |
| Secondary_{—} | | ACK but no | NACK but | or is a PRE or |
| Cell_Active | Condition | NACK | no ACK | is a POST |
| 4 | Secondary_Cell_Enabled | Δ_{ACK} + 3 | Δ_{NACK} + 3 | MAX(Δ_{ACK} + 3, |
| | is 4 and MIMO is not | | | Δ_{NACK} + 3) |
| | configured in any cell | | | |
| | Otherwise | Δ_{ACK} + 4 | Δ_{NACK} + 4 | MAX(Δ_{ACK} + 4, |
| | | | | Δ_{NACK} + 4) |
| 5 | Secondary_Cell_Enabled | Δ_{ACK} + 3 | Δ_{NACK} + 3 | MAX(Δ_{ACK} + 3, |
| | is 5 and MIMO is not | | | Δ_{NACK} + 3) |
| | configured in any cell | | | |
| | Otherwise | Δ_{ACK} + 4 | Δ_{NACK} + 4 | MAX(Δ_{ACK} + 4, |
| | | | | Δ_{NACK} + 4) |

Alternatively, the special case of 6C/5C without MIMO (SF=128) and with MIMO (SF=64) may be treated the same, and the HARQ-ACK power offset settings for 6C/5C without MIMO (SF=128) may be defined as in Tables 25 or 26.

It should be noted that the power offset proposed in Table 25 through Table 28 for both general and special case may be jointly specified in a combined table in various forms.

Similarly, for the special cases of 8C/7C configuration without MIMO when SF=128 is used, the power offset may be reduced by 1 as compared to the corresponding configuration with the general case where SF=64 is used. Alternatively, different HARQ power offset setting from Table 27 and 28 may be defined to account for the performance of the joint codebook for 4 serving cells in Table 22.

In 8C-HSDPA, different HS-DPCCH channel formats are used based on the number of carriers configured/activated at the WTRU. The CQI power offset may be dependent on the number of carriers that have MIMO configured. In a case where an HS-DPCCH CQI transmission is on a per carrier basis in 8C-HSDPA with a minimum feedback cycle of 4 ms and a different processing gain, (i.e., SF=128 used for the special case of 6C/5C or 8C/7C configuration without MIMO and SF=64 for the rest configuration in 8C-HSDPA), the HS-DPCCH power setting for HS-DPCCH slots carrying CQI is set forth below.

In 8C-HSDPA, if Secondary_Cell_Active>3 when SF=64 is used, the CQI power offset setting may be defined as in Table 29.

TABLE 29

| | | Aₕₛ equals the quantized amplitude | | |
|---|---|---|---|---|
| | | ratio translated from | | |
| | | MIMO is | MIMO is | |
| | | not | configured in a cell | |
| Secondary_{—} | | configured | CQI of | CQI of |
| Cell_Active | Condition | in a cell | Type A | Type B |
| 0 | — | Δ_{CQI} | Δ_{CQI} + 1 | Δ_{CQI} |
| 1 | Secondary_Cell_{—} | Δ_{CQI} + 1 | N/A | N/A |
| | Enabled is 1 and | | | |
| | MIMO is not con- | | | |
| | figured in any | | | |
| | cell | | | |
| | Otherwise | Δ_{CQI} | Δ_{CQI} + 1 | Δ_{CQI} |
| 2 | Secondary_Cell_{—} | Δ_{CQI} | N/A | N/A |
| (Note 1) | Enabled is 2 and | | | |
| 2 | MIMO is not con- | Δ_{CQI} + 1 | N/A | N/A |
| (Note 2) | figured in any | | | |
| | cell | | | |
| 2 | Otherwise | Δ_{CQI} + 1 | Δ_{CQI} + 2 | Δ_{CQI} + 1 |
| 3 | | Δ_{CQI} + 1 | Δ_{CQI} + 2 | Δ_{CQI} + 1 |
| 4 | | Δ_{CQI} + 2 | Δ_{CQI} + 3 | Δ_{CQI} + 2 |
| 5 | | Δ_{CQI} + 2 | Δ_{CQI} + 3 | Δ_{CQI} + 2 |
| 6 | | Δ_{CQI} + 2 | Δ_{CQI} + 3 | Δ_{CQI} + 2 |
| 7 | | Δ_{CQI} + 2 | Δ_{CQI} + 3 | Δ_{CQI} + 2 |

Note 1:
When the WTRU transmits a CQI report for the serving HS-DSCH cell in a subframe.
Note 2:
When the WTRU transmits a composite CQI report for 1^{st} and 2^{nd} secondary serving HS-DSCH cells in a subframe.

Alternatively, to conservatively compensate the loss of processing gain due to SF=64, the CQI power offset setting may be defined as in Table 30.

TABLE 30

| | | Aₕₛ equals the quantized amplitude | | |
|---|---|---|---|---|
| | | ratio translated from | | |
| | | MIMO is | MIMO is | |
| | | not | configured in a cell | |
| Secondary_{—} | | configured | CQI of | CQI of |
| Cell_Active | Condition | in a cell | Type A | Type B |
| 0 | — | Δ_{CQI} | Δ_{CQI} + 1 | Δ_{CQI} |
| 1 | Secondary_Cell_{—} | Δ_{CQI} + 1 | N/A | N/A |
| | Enabled is 1 and | | | |
| | MIMO is not con- | | | |
| | figured in any | | | |
| | cell | | | |
| 1 | Otherwise | Δ_{CQI} | Δ_{CQI} + 1 | Δ_{CQI} |
| 2 | Secondary_Cell_{—} | Δ_{CQI} | N/A | N/A |
| (note 1) | Enabled is 2 and | | | |
| 2 | MIMO is not con- | Δ_{CQI} + 1 | N/A | N/A |
| (note 2) | figured in any | | | |
| | cell | | | |
| 2 | Otherwise | Δ_{CQI} + 1 | Δ_{CQI} + 2 | Δ_{CQI} + 1 |
| 3 | | Δ_{CQI} + 1 | Δ_{CQI} + 2 | Δ_{CQI} + 1 |
| 4 | | Δ_{CQI} + 3 | Δ_{CQI} + 4 | Δ_{CQI} + 3 |
| 5 | | Δ_{CQI} + 3 | Δ_{CQI} + 4 | Δ_{CQI} + 3 |
| 6 | | Δ_{CQI} + 3 | Δ_{CQI} + 4 | Δ_{CQI} + 3 |
| 7 | | Δ_{CQI} + 3 | Δ_{CQI} + 4 | Δ_{CQI} + 3 |

Note 1:
When the WTRU transmits a CQI report for the serving HS-DSCH cell in a subframe.
Note 2:
When the WTRU transmits a composite CQI report for first and second secondary serving HS-DSCH cells in a subframe.

For the special cases of 6C/5C without MIMO when SF=128 is used, depending on layout of CQI for 6C/5C, a WTRU may transmit a CQI report for a single cell in a slot, or the WTRU may transmit a composite CQI report for a pair of cells in a subframe or a slot if this pair of cells are laid out with another single cell into a subframe.

For example, in a case of 5C, CQIs for the serving HS-DSCH cell and the first and second secondary serving HS-DSCH cells may be reported in one subframe (e.g., two of these three cells may be jointly coded and the composite CQI report for these two cells is put into one slot of the subframe, and the CQI for the third single cell is put into another slot of the subframe). The third and fourth secondary serving HS-DSCH cells may be jointly coded and the composite CQI report for these two cells may be put in another subframe (e.g., the next subframe if the minimum CQI feedback cycle of 4 ms is required).

For another example, in a case of 6C, two sets of CQIs may be respectively allocated to two consecutive subframes to maintain a minimum feedback cycle of 4 ms. Each set of CQIs may correspond to three cells. Within one subframe, two of three cells may be jointly coded and the composite CQI report is allocated in one slot of the subframe, and the third cell may be allocated into another slot of the subframe.

The CQI power offset setting when Secondary_Cell_Active=4 or 5 without MIMO and SF=128 may be defined as in Table 31. Alternatively, the CQI power offset setting when Secondary_Cell_Active=4 or 5 without MIMO and SF=128 may be defined as in Table 32. Either example may be used to replace the rows when Secondary_Cell_Active=4 and/or 5 in Table 29 or Table 30.

TABLE 31

| | | Aₕₛ equals the quantized amplitude | | |
|---|---|---|---|---|
| | | ratio translated from | | |
| | | MIMO is | MIMO is | |
| | | not | configured in a cell | |
| Secondary_{—} | | configured | CQI of | CQI of |
| Cell_Active | Condition | in a cell | Type A | Type B |
| 4 | Secondary_Cell_{—} | Δ_{CQI} + 1 | N/A | N/A |
| (Note 3) | Enabled is 4 and | | | |
| 4 | MIMO is not con- | Δ_{CQI} + 1 | N/A | N/A |
| (Note 4) | figured in any | | | |
| 4 | cell | Δ_{CQI} + 2 | N/A | N/A |
| (Note 5) | | | | |
| 4 | Otherwise | Δ_{CQI} + 2 | Δ_{CQI} + 3 | Δ_{CQI} + 2 |
| 5 | Secondary_Cell_{—} | Δ_{CQI} + 1 | N/A | N/A |
| (Note 4) | Enabled is 5 and | | | |
| 5 | MIMO is not con- | Δ_{CQI} + 2 | N/A | N/A |
| (Note 5) | figured in any | | | |
| | cell | | | |
| 5 | Otherwise | Δ_{CQI} + 2 | Δ_{CQI} + 3 | Δ_{CQI} + 2 |

Note 3:
When the WTRU transmits a CQI report for a pair of cells in a subframe.
Note 4:
When the WTRU transmits a CQI report for a single cell in a slot
Note 5:
When the WTRU transmits a composite CQI report for a pair of cells in a slot.

TABLE 32

| | | Aₕₛ equals the quantized amplitude | | |
|---|---|---|---|---|
| | | ratio translated from | | |
| | | MIMO is | MIMO is | |
| | | not | configured in a cell | |
| Secondary_{—} | | configured | CQI of | CQI of |
| Cell_Active | Condition | in a cell | Type A | Type B |
| 4 | Secondary_Cell_{—} | Δ_{CQI} + 1 | N/A | N/A |
| (Note 3) | Enabled is 4 and | | | |
| 4 | MIMO is not con- | Δ_{CQI} + 1 | N/A | N/A |
| (Note 4) | figured in any | | | |
| 4 | cell | Δ_{CQI} + 2 | N/A | N/A |
| (Note 5) | | | | |
| 4 | Otherwise | Δ_{CQI} + 3 | Δ_{CQI} + 4 | Δ_{CQI} + 3 |
| 5 | Secondary_Cell_{—} | Δ_{CQI} + 1 | N/A | N/A |
| (Note 4) | Enabled is 5 and | | | |
| 5 | MIMO is not con- | Δ_{CQI} + 2 | N/A | N/A |
| (Note 5) | figured in any | | | |
| | cell | | | |
| 5 | Otherwise | Δ_{CQI} + 3 | Δ_{CQI} + 4 | Δ_{CQI} + 3 |

Note 3:
When the WTRU transmits a CQI report for a pair of cells in a subframe.
Note 4:
When the WTRU transmits a CQI report for a single cell in a slot
Note 5:
When the WTRU transmits a composite CQI report for a pair of cells in a slot.

Alternatively, for simplicity, the special case of 6C/5C configuration without MIMO (SF=128) and with MIMO (SF=64) configured may be treated the same, and the CQI power offset settings for the case of 6C/5C without MIMO (SF=128) may be defined as in Table 29 or Table 30.

When 2 HS-DPCCHs with SF=128 are used, both HS-DPCCH1 and HS-DPCCH2 may use the same set of Δ_{ACK}, Δ_{NACK} and Δ_{CQI} signaled from higher layer. However, the WTRU may independently select the power offset settings for each HS-DPCCH slot based on the number of active cells mapped on HS-DPCCH1 and HS-DPCCH2 individually, which may result in the same or different power offset settings for two HS-DPCCHs. Alternatively, the two HS-DPCCHs may use different power offset settings. For example, the power offset for HS-DPCCH2 may be defined with a differential value, Δₕₛ_{_{—}}₂₁ (dB), with the power offset for HS-DPCCH1, where Δₕₛ_{_{—}}₂₁ (dB) denotes the power offset differential value for HS-DPCCH2 with respective to HS-DPCCH1. Δₕₛ_{_{—}}₂₁ may be defined the same or different values for HARQ-ACK field and PCI/CQI field. Δₕₛ_{_{—}}₂₁ may be the same or different value for different slots within one HS-DPCCH sub-frame (TTI). Δₕₛ_{_{—}}₂₁ may be a pre-defined value or signaled from higher layers.

The power offset for each HS-DPCCH may be determined based on the number of active cells mapped on corresponding HS-DPCCH (i.e., HS-DPCCH1 or HS-DPCCH2) individually and MIMO configuration status. For example, the power offset settings for 4C-HSDPA may be reused in 8C-HSDPA by introducing two new terms: Secondary_Cell_Active_{—}1 and Secondary_Cell_Active_{—}2 that are defined as the number of activated secondary serving HS-DSCH cells within HS-DPCCH1 and HS-DPCCH2, respectively. Assuming that a serving HS-DSCH cell is mapped to HS-DPCCH1, which may not be deactivated, Secondary_Cell_Active=(Secondary_Cell_Active_{—}1+Secondary_Cell_Active 2), and Secondary_Cell_Active may be replaced with Secondary_Cell_Active_{—}1 for HS-DPCCH1, and Secondary_Cell_Active may be replaced with (Secondary_Cell_Active_{—}2-1) for HS-DPCCH2. Table 33 and Table 34 show an example of CQI power offset setting for HS-DPCCH1 and HS-DPCCH2 (if not DTXed), respectively. The HARQ-ACK power offsetting for HS-DPCCH1 and HS-DPCCH2 (if not DTXed) may be obtained similarly.

TABLE 33

| | | Aₕₛ equals the quantized amplitude | | |
|---|---|---|---|---|
| | | ratio translated from | | |
| | | MIMO is | MIMO is | |
| | | not | configured in a cell | |
| Secondary_{—} | | configured | CQI of | CQI of |
| Cell_Active_1 | Condition | in a cell | Type A | Type B |
| 0 | | Δ_{CQI} | Δ_{CQI} + 1 | Δ_{CQI} |
| 1 | Secondary_Cell_{—} | Δ_{CQI} + 1 | N/A | N/A |
| | Enabled is 1 and | | | |
| | MIMO is not con- | | | |
| | figured in any | | | |
| | cell | | | |
| | Otherwise | Δ_{CQI} | Δ_{CQI} + 1 | Δ_{CQI} |
| 2 | Secondary_Cell_{—} | Δ_{CQI} | N/A | N/A |
| (note 1) | Enabled is 2 and | | | |
| 2 | MIMO is not con- | Δ_{CQI} + 1 | N/A | N/A |
| (note 2) | figured in any | | | |
| | cell | | | |
| 2 | Otherwise | Δ_{CQI} + 1 | Δ_{CQI} + 2 | Δ_{CQI} + 1 |
| 3 | | Δ_{CQI} + 1 | Δ_{CQI} + 2 | Δ_{CQI} + 1 |

Note 1:
When the WTRU transmits a CQI report for the serving HS-DSCH cell in a subframe.
Note 2:
When the WTRU transmits a composite CQI report for first and second secondary serving HS-DSCH cells in a subframe.

TABLE 34

| | | Aₕₛ equals the quantized amplitude | | |
|---|---|---|---|---|
| | | ratio translated from | | |
| | | MIMO is | MIMO is | |
| (Secondary_{—} | | not | configured in a cell | |
| Cell_Active_{—} | | configured | CQI of | CQI of |
| 2 - 1) | Condition | in a cell | Type A | Type B |
| 0 | | Δ_{CQI} | Δ_{CQI} + 1 | Δ_{CQI} |
| 1 | Secondary_Cell_{—} | Δ_{CQI} + 1 | N/A | N/A |
| | Enabled is 1 and | | | |
| | MIMO is not con- | | | |
| | figured in any | | | |
| | cell | | | |
| 1 | Otherwise | Δ_{CQI} | Δ_{CQI} + 1 | Δ_{CQI} |
| 2 | Secondary_Cell_{—} | Δ_{CQI} | N/A | N/A |
| (note 1) | Enabled is 2 and | | | |
| 2 | MIMO is not con- | Δ_{CQI} + 1 | N/A | N/A |
| (note 2) | figured in any | | | |
| | cell | | | |
| 2 | Otherwise | Δ_{CQI} + 1 | Δ_{CQI} + 2 | Δ_{CQI} + 1 |
| 3 | | Δ_{CQI} + 1 | Δ_{CQI} + 2 | Δ_{CQI} + 1 |

Note 1:
When the WTRU transmits a CQI report for the serving HS-DSCH cell in a subframe.
Note 2:
When the WTRU transmits a composite CQI report for first and second secondary serving HS-DSCH cells in a subframe.

The PRE/POST codewords are introduced in the HARQ-ACK codebook for the purpose of reducing the occurrence of false alarms and thus improve the ACK/NACK detection reliability. When this feature is enabled by the network with HARQ_preamble_mode=1, the Node B does not have to distinguish ACK/NACKs from DTX (i.e., no transmission of any signals) for the sub-frames after PRE and before POST. As the probability of missed detection, which is directly affected by the false alarm setting, is the dominant source of ACK/NACK decoding error, the use of the PRE/POST would significantly improve the ACK/NACK detection performance.

If one HS-DPCCH with SF=64 (i.e., HS-DPCCH slot format 2) is used in 8C-HSDPA, four HARQ-ACK messages as shown in FIG. 10 are introduced in one HARQ-ACK slot in an HS-DPCCH sub-frame. In addition, a DTX codeword (DCW) is included the codebook to avoid non-full-slot transmissions. Under this assumption, the true DTX, (i.e., transmitting no signal in the HARQ-ACK slot), occurs if DTX is reported on all 4 HARQ-ACK messages.

N_acknack_transmit is a repetition factor of ACK/NACK. N_cqi_transmit is a repetition factor of CQI. HARQ_preamble_mode indicates a status of preamble/postamble transmission. Inter-TTI is a set number of periods that define the time from the beginning of one HS-PDSCH transmission to the next HS-PDSCH transmission.

If HARQ_preamble_mode=1 and the information received on an HS-SCCH is not discarded, the WTRU may transmit an HARQ preamble, (i.e., PRE for HS-DPCCH slot format 0, PRE/PRE for HS-DPCCH slot format 1, and PRE/PRE/PRE/PRE for HS-DPCCH slot format 2), in the slot allocated to HARQ-ACK in the HS-DPCCH sub-frame n−1, unless an ACK or NACK or any combination of ACK and NACK is to be transmitted in sub-frame n−1 as a result of an HS-DSCH transmission earlier than sub-frame n on the HS-PDSCH. If N_acknack_transmit>1, the WTRU may transmit an HARQ preamble in the slot allocated to HARQ-ACK in the HS-DPCCH sub-frame n−2, unless an ACK or NACK or any combination of ACK and NACK is to be transmitted in sub-frame n−2 as a result of an HS-DSCH transmission earlier than sub-frame n on the HS-PDSCH.

The WTRU may transmit the ACK/NACK information received from MAC-hs or MAC-ehs in the slot allocated to the HARQ-ACK in the corresponding HS-DPCCH sub-frame. When N_acknack_transmit is greater than one, the WTRU may repeat the transmission of the ACK/NACK information over the next (N_acknack_transmit-1) consecutive HS-DPCCH sub-frames, in the slots allocated to the HARQ-ACK, and may not attempt to receive any HS-SCCH in the HS-SCCH subframes corresponding to the HS-DPCCH sub-frames in which the ACK/NACK information transmission is repeated, nor to receive or decode transport blocks from the HS-PDSCH in the HS-DSCH sub-frames corresponding to the HS-DPCCH sub-frames in which the ACK/NACK information transmission is repeated.

If ACK or NACK or any combination of ACK and NACK is transmitted in HS-DPCCH sub-frame n, and HARQ_preamble_mode=1 and WTRU InterTTI≦N_acknack_transmit, the WTRU may transmit an HARQ postamble, (i.e., POST for HS-DPCCH slot format 0, POST/POST for HS-DPCCH slot format 1, and POST/POST/POST/POST for HS-DPCCH slot format 2), in the slot allocated to HARQ-ACK in HS-DPCCH subframe n+2*N_acknack_transmit-1, unless ACK or NACK or PRE or PRE/PRE or PRE/PRE/PRE/PRE or any combination of ACK and NACK is to be transmitted in this subframe. If N_acknack_transmit>1, transmit an HARQ postamble (POST) in the slot allocated to HARQ-ACK in the HS-DPCCH subframe n+2*N_acknack_transmit−2, unless an ACK or NACK or PRE or PRE/PRE or PRE/PRE/PRE/PRE or any combination of ACK and NACK is to be transmitted in this subframe.

The rules specified above in transmitting PRE/POST require PRE/POST to be sent on all ACK/NACK messages in a subframe. Alternatively, one or part of the 4 messages may be a PRE/POST codeword, and the rest of them may be a DTX codeword instead.

In a case of two SF=128 HS-DPCCHs in 8C-HSDPA, the PRE/POST maybe independently transmitted on each of the two HS-DPCCHs on a per-channel basis. If HARQ_preamble_mode=1 and the information received on an HS-SCCH is not discarded, a WTRU may transmit an HARQ preamble, (i.e., PRE for HS-DPCCH slot format 0, and PRE/PRE for HS-DPCCH slot format 1), in the slot allocated to HARQ-ACK in HS-DPCCHᵢ sub-frame n−1, unless an ACK or NACK or any combination of ACK and NACK is to be transmitted in sub-frame n−1 as a result of an HS-DSCH transmission earlier than sub-frame n on the HS-PDSCH. If N_acknack_transmit>1, the WTRU may transmit an HARQ preamble in the slot allocated to HARQ-ACK in HS-DPCCHᵢ sub-frame n−2, unless an ACK or NACK or any combination of ACK and NACK is to be transmitted in sub-frame n−2 as a result of an HS-DSCH transmission earlier than sub-frame n on the HS-PDSCH.

The WTRU may transmit the ACK/NACK information received from MAC-hs or MAC-ehs in the slot allocated to the HARQ-ACK in the corresponding HS-DPCCHᵢ sub-frame. When N_acknack_transmit is greater than one, the WTRU may repeat the transmission of the ACK/NACK information over the next (N_acknack_transmit-1) consecutive HS-DPCCHᵢ sub-frames, in the slots allocated to the HARQ-ACK and may not attempt to receive any HS-SCCH in HS-SCCH subframes corresponding to HS-DPCCHᵢ sub-frames in which the ACK/NACK information transmission is repeated, nor to receive or decode transport blocks from the HS-PDSCH in HS-DSCH sub-frames corresponding to HS-DPCCHᵢ sub-frames in which the ACK/NACK information transmission is repeated.

If ACK or NACK or any combination of ACK and NACK is transmitted in HS-DPCCHᵢ sub-frame n, and HARQ_preamble_mode=1 and WTRU InterTTI≦N_acknack_transmit, the WTRU may transmit an HARQ postamble, (i.e., POST for HS-DPCCH slot format 0, and POST/POST for HS-DPCCH slot format 1), in the slot allocated to HARQ-ACK in HS-DPCCHᵢ subframe n+2*N_acknack_transmit−1, unless ACK or NACK or PRE or PRE/PRE or any combination of ACK and NACK is to be transmitted in this subframe. If N_acknack_transmit>1, the WTRU may transmit an HARQ postamble (POST) in the slot allocated to HARQ-ACK in HS-DPCCHᵢ subframe n+2*N_acknack_transmit−2, unless an ACK or NACK or PRE or PRE/PRE or any combination of ACK and NACK is to be transmitted in this subframe. DTX may be used on the HS-DPCCHᵢ in the slot allocated to HARQ-ACK in the corresponding HS-DPCCH subframe unless a HARQ-ACK message is to be transmitted as described above.

Alternatively, a HARQ preamble and a HARQ postamble may be transmitted on the two HS-DPCCHs simultaneously if both HS-DPCCHs meet the requirements defined for a single HS-DPCCH as the independent PRE/POST transmission described above. As an example of 2×SF128 HS-DPCCHs used in 8C-HSDPA, if two HS-DPCCHs are active, a HARQ preamble (i.e., PRE/PRE for HS-DPCCH slot format 1, SF=128) may be sent on both HS-DPCCHs (i.e., each of HS-DPCCH1 and HS-DPCCH2) prior to a transmission and a HARQ postamble (i.e., POST/POST for HS-DPCCH slot format 1, SF=128) may be sent on both HS-DPCCHs (i.e., each of HS-DPCCH1 and HS-DPCCH2) subsequent to a transmission described above. DTX may be used on HS-DPCCH1 and HS-DPCCH2 in the slot allocated to HARQ-ACK in each of the corresponding HS-DPCCH subframes unless a HARQ-ACK message is to be transmitted as described above on either of the HS-DPCCHs. If a HARQ-ACK message is to be transmitted on only one of the active HS-DPCCHs, the DTX codeword may be repeated in the HARQ-ACK field on the other HS-DPCCH in the corresponding HS-DPCCH subframe.

Embodiments for reporting in compressed mode gap for multi-carrier HSDPA are described hereafter.

During a compressed mode (CM) on the associated dedicated physical channel (DPCH) or fractional dedicated physical channel (F-DPCH), a WTRU may neglect HS-SCCH or HS-PDSCH transmissions, if a part of the HS-SCCH or a part of the corresponding HS-PDSCH overlaps with a downlink transmission gap on the associated DPCH or F-DPCH. In this case, neither ACK, nor NACK may be transmitted by the WTRU to respond to the corresponding downlink transmission. If a part of an HS-DPCCH slot allocated to HARQ-ACK overlaps with an uplink transmission gap on the associated DPCH, the WTRU may use DTX on the HS-DPCCH in that HS-DPCCH slot. If, in an HS-DPCCH sub-frame, a part of a slot allocated for CQI information overlaps with an uplink transmission gap on the associated DPCH, the WTRU may not transmit that CQI or composite PCI/CQI information in that sub-frame (if HS-DPCCH slot format 0 is used) or in that slot (if HS-DPCCH slot format 1 is used). If a CQI report or a composite PCI/CQI report is scheduled in the current CQI field, and the corresponding 3-slot reference period wholly or partly overlaps a downlink transmission gap, the WTRU may use DTX in the current CQI field and in the CQI fields in the next (N_cqi_transmit-1) subframes.

In a case where two SF=128 HS-DPCCHs are used in 8C-HSDPA, when two HS-DPCCHs are simultaneously transmitted and timing-aligned, the above rule may be applied for each or both of the two HS-DPCCHs. If one HS-DPCCH is transmitted upon activation/deactivation, the above rule may be applied for the transmitted HS-DPCCH.

With the introduction of dual band dual carrier (DB-DC) HSDPA, which is characterized by a WTRU having two receivers capable of simultaneous reception in two different bands, DL carriers in a multi-carrier HSDPA system including the DB-DC HSDPA, 4C-HSDPA, 8C-HSDPA and/or higher number carrier HSDPA system may be configured in two bands. A subset or none of the configured carriers/bands may be put into the compressed mode, thus allowing uninterrupted data transmission on the other carriers/bands when frequency-band-specific compressed mode (CM) is configured. The above rule is defined for the compressed mode, which is per WTRU basis instead of per band. When introducing the frequency-band-specific CM, there are several issues to be addressed as follows.

A first issue with the frequency-band-specific CM is how the WTRU handles the reception of an HS-SCCH and an HS-PDSCH during the frequency-band-specific CM on the associated DPCH or F-DPCH.

In on embodiment, the WTRU may handle the reception of an HS-SCCH and an HS-PDSCH on a per-band basis during the frequency-band-specific CM on the associated DPCH or F-DPCH. For the band(s) configured with frequency-band-specific CM on the associated DPCH or F-DPCH, the WTRU may neglect an HS-SCCH or HS-PDSCH transmission on all carriers within the band(s), if a part of the HS-SCCH or a part of the corresponding HS-PDSCH overlaps with a downlink transmission gap on the associated DPCH or F-DPCH. In this case, neither ACK, nor NACK may be transmitted by the WTRU to respond to the corresponding downlink transmission. If the related HARQ-ACK field is jointly coded with that of any of the downlink transmission belonging to the other frequency band, the WTRU may respond with a DTX codeword to the corresponding downlink transmission. Otherwise, the WTRU may not transmit (true DTX). Alternatively, the WTRU may use the codeword in the ACK-NACK codebook as if the corresponding cells in the band are deactivated. This embodiment may also be applied to the cases where a single band is configured or 4C-HSDPA is configured.

For the band(s) without being configured with frequency-band-specific CM on the associated DPCH or F-DPCH, the WTRU may operate as normal without CM, (i.e., the WTRU may receive an HS-SCCH or HS-PDSCH transmission on any carriers within the band(s)), if a part of the HS-SCCH or a part of the corresponding HS-PDSCH overlaps with a downlink transmission gap on the associated DPCH or F-DPCH. In this case, either ACK, or NACK, or DTX codeword may be transmitted, or no signal may be transmitted (true DTX), by the WTRU to respond to the corresponding downlink transmission.

In another embodiment, regardless of the frequency bands, the WTRU may neglect the HS-SCCH or HS-PDSCH transmission on any carriers of all configured bands, if a part of the HS-SCCH or a part of the corresponding HS-PDSCH overlaps with a downlink transmission gap on the associated DPCH or F-DPCH. In this case, neither ACK, nor NACK may be transmitted by the WTRU to respond to the corresponding downlink transmission. The true DTX may be performed by the WTRU in response to all downlink transmissions.

The second issue with the frequency-band-specific CM is how the WTRU reports CQI or PCI/CQI during the frequency-band-specific CM on the associated DPCH or F-DPCH.

In one embodiment, CQI reporting may not be allowed for any of the HSPDA cells in any configured frequency band when any carrier is in a CM. Specially, this may simply follow the conventional CM rules and DTX the CQI reporting. If a CQI report or a composite PCI/CQI report is scheduled in the current CQI field and the corresponding 3-slot reference period wholly or partly overlaps a downlink transmission gap, the WTRU may use DTX in the current CQI field and in the CQI fields in the next (N_cqi_transmit-1) subframes for all HSDPA cells regardless whether the frequency band is configured with or without the frequency-band-specific CM.

In another embodiment, CQI reporting may be allowed for HSDPA cells in all configured frequency bands. This may be applied when a subset or none of the configured carriers/band can be put into the CM gap and the primary carrier is not in CM gap. For example, this happens when one or more secondary carriers is configured with a CM gap and the primary carrier (or secondary carrier associated with the secondary UL carrier if HS-DPCCH is carried on the secondary UL carrier) does not have a CM gap. This embodiment may also be performed for jointly encoded CQI case.

If a CQI report or a composite PCI/CQI report is scheduled in the current CQI field, and the corresponding 3-slot reference period wholly or partly overlaps a downlink transmission gap, the WTRU may report CQI or PCI/CQI in a way as defined with respect to the third issue disclosed below in the current CQI field and in the CQI fields in the next (N_cqi_transmit-1) subframes.

Alternatively, CQI reporting may be allowed for the HSDPA cells in the band not being configured with the frequency-band-specific CM, and CQI reporting may not be allowed for the HSDPA cells in the band configured with the frequency-band-specific CM. This may be feasible for the time-multiplexed CQI case in MC-HSDPA. For the band(s) configured with frequency-band-specific CM on the associated DPCH or F-DPCH, if a CQI report or a composite PCI/CQI report is scheduled in the current CQI field, and the corresponding 3-slot reference period wholly or partly overlaps a downlink transmission gap, the WTRU may use DTX in the current CQI field and in the CQI fields in the next (N_cqi_transmit-1) subframes. For the band(s) not being configured with frequency-band-specific CM, if a CQI report or a composite PCI/CQI report is scheduled in the current CQI field, and the corresponding 3-slot reference period wholly or partly overlaps a downlink transmission gap, the WTRU may report the CQI or PCI/CQI in a way as defined with respect to the third issue disclosed below in the current CQI field and in the CQI fields in the next (N_cqi_transmit-1) subframes.

The third issue with the frequency-band-specific CM is what CQI or PCI/CQI need to be reported during the frequency-band-specific CM on the associated DPCH or F-DPCH. For the band(s) not in the frequency-band-specific CM, the legacy definition of CQI or PCI/CQI may be reused.

For the band experiencing a gap upon the configured frequency-band-specific CM, if there is no valid PCI/CQI, the previous (e.g., the last) valid PCI/CQI may be repeated before the corresponding 3-slot reference period wholly or partly overlaps a downlink transmission gap.

Alternatively, a special CQI or PCI/CQI codeword (or value) may be reported when there is no valid CQI or PCI/CQI to report corresponding to the CM gap. The special CQI codeword may be one or any combination of the following: a new CQI DTX codeword, an “out-of-range” CQI value with respective to the normal range of CQI value, (e.g., CQI value=0 or CQI value=31 for the case without MIMO configured or MIMO configured and single-stream restriction configured, or CQI value=15 for case with MIMO configured and single-stream restriction not configured), an agreed upon CQI or PCI/CQI codeword when there is no valid CQI or PCI/CQI measurement to report, (e.g., the WTRU may use the out of range CQI for most cases and/or may use the maximum CQI value for cases where there is no out of range CQI value). Alternatively, it may be DTXed, (i.e., not reporting CQI or PCI/CQI).

Alternatively, the CQI and PCI/CQI may be reported as if the secondary cell is deactivated during the CM gap, and the deactivated secondary cell's CQI or PCI/CQI is not transmitted (i.e., DTXed) during the time the measurements are interrupted. This embodiment may not use the remapping/repeating rule when the number of activated carriers is no more than 2 in 4C-HSDPA or the cases defined for 8C-HSDPA since CM may not change the number of activated carriers which is also linked to power offset for HS-DPCCH. Alternatively, a new remapping/repeating rule and corresponding new power offset for this case may be defined.

Embodiments for enhanced dedicated channel (E-DCH) transport format combination (E-TFC) restriction for 8C-HSDPA are described hereafter.

In 3GPP previous releases, in order to maximize the coverage, a WTRU may limit the usage of transport format combinations (TFCs) for the assigned transport format set if it estimates that a certain TFC and E-TFC would require more power than a maximum transmit power. E-TFC selection is based on the estimated power left over from TFC selection if a dedicated physical data channel (DPDCH) is present and from HS-DPCCH as follows. If an HS-DPCCH is transmitted either partially or totally within the given measurement period, the WTRU transmit power estimation for a given TFC is calculated based on DPDCH and dedicated physical control channel (DPCCH) gain factors, the maximum value of the HS-DPCCH gain factor that is used during the measurement period, and the reference transmit power. The timing of the measurement period (which is one slot) is same as the timing of the dedicated physical channel (DPCH) slot.

E-TFC restriction procedure involves determining a normalized remaining power margin (NRPM) available for the E-TFC selection for the activated uplink frequency (or frequencies if DC-HSUPA configured). The NRPM for E-TFC candidate j (NRPMⱼ) is calculated as follows.

When a WTRU has one activated uplink frequency, NRPM; is calculated as follows:

NRPMⱼ=(PMaxⱼ−P_{DPCCH,target}−P_{DPDCH}−P_{HS-DPCCH}−P_{E-DPCCH,j})/P_{DPCCH,target}. Equation (1)

PMaxⱼ is a maximum WTRU transmitter power for E-TFCⱼ. P_{DPCCH}(t) represents a slotwise estimate of the current WTRU DPCCH power at time t. If at time t the WTRU is transmitting a CM frame then P_{DPCCH,comp}(t)=P_{DPCCH}(t)×(N_{pilot, C}/N_{pilot,N}); otherwise, P_{DPCCH,comp}(t)=P_{DPCCH}(t). If the WTRU is not transmitting uplink DPCCH during the slot at time t, either due to CM gaps or when discontinuous uplink DPCCH transmission operation is enabled, the power may not contribute to the filtered result. Samples of P_{DPCCH,comp}(t) may be filtered using a filter period of 3 slotwise estimates of P_{DPCCH,comp}(t) when the E-DCH transmit time interval (TTI) is 2 ms or 15 slotwise estimates of P_{DPCCH,comp}(t) when the E-DCH TTI is 10 ms to give P_{DPCCH,filtered}. If the target E-DCH TTI for which NRPMⱼ evaluated does not correspond to a CM frame then P_{DPCCH,target}=P_{DPCCH,filtered}. If the target E-DCH TTI for which NRPMⱼ is evaluated corresponds to a CM frame then P_{DPCCH,target}=P_{DPCCH,filtered}×(N_{pilot,N}/N_{pilot, C}). N_{pilot,N} and N_{pilot, C} are numbers of pilot symbols as defined in 3GPP TS 25.214.

P_{DPDCH} is an estimated DPDCH transmit power, based on P_{DPCCH,target} and the gain factors from the TFC selection that has been made. P_{HS-DPCCH} is an estimated HS-DPCCH transmit power based on the maximum HS-DPCCH gain factor based on P_{DPCCH,target} and the most recent signaled values of Δ_{ACK}, Δ_{NACK} and Δ_{CQI}. If the target E-DCH TTI for which NRPMⱼ is evaluated corresponds to a CM frame, the modification to the gain factors due to CM is included in the estimate of P_{HS-DPCCH}. P_{E-DPCCH,j} is an estimated E-DPCCH transmit power for E-DCH transport format combination index j (E-TFCIⱼ).

If the WTRU is configured in MIMO without DC-HSDPA mode, the estimated HS-DPCCH transmit power may be based on P_{DPCCH,target} and the greatest of (Δ_{ACK}+1), (Δ_{NACK}+1) and (Δ_{CQI}+1) when CQI of type A is to be transmitted, and the greatest of (Δ_{ACK}+1), (Δ_{NACK}+1) and Δ_{CQI} when CQI of type B is to be transmitted, where Δ_{ACK}, Δ_{NACK} and Δ_{CQI} are the most recent signaled values.

If the WTRU is configured in DC-HSDPA or DC-HSDPA-MIMO, the estimated HS-DPCCH transmit power may be based on P_{DPCCH,target} and the greatest of (Δ_{ACK}+1), (Δ_{NACK}+1) and (Δ_{CQI}+1), where Δ_{ACK}, Δ_{NACK} and Δ_{CQI} are the most recent signaled values.

When the WTRU has more than one activated uplink frequency, the WTRU may estimate the NRPM available for E-TFC selection for the i-th activated uplink frequency (where i=1 or 2 respectively corresponds to the index of the primary uplink frequency and the index of the secondary uplink frequency) based on the following equation for E-TFC candidate j:

NRPM_{i,j}=(P_{allocated},P_{E-DPCCHi,j})/P_{DPCCH,target,i} Equation (2)

where P_{allocated,i} indicates the power allocated to the i-th uplink frequency by the WTRU based on the following cases, and P_{E-DPCCHi,j} represents the estimated E-DPCCH transmit power for E-TFCIⱼ on the activated uplink frequency i.

In a case where a WTRU has more than one activated uplink frequency and no retransmission is required, or where a WTRU has more than one activated uplink frequency and two retransmissions are required,

P_{allocated,1}=P₁+P_{non-SG}, and

P_{allocated,2}=P₂,

where Pᵢ represents the maximum remaining allowed power for scheduled transmissions for the i-th activated uplink frequency, and P_{non-SG} represents the power pre-allocated for non-scheduled transmissions for the primary uplink frequency. Pᵢ is defined as follows:

$${P}_{i} = {P}_{remaining , s} \frac{{P}_{DPCCH , target , i} {SG}_{i}}{{\sum }_{k} {P}_{DPCCH , target , k} {SG}_{k}} \qquad Equation ( 3 )$$

where P_{remaining,s} is the remaining power for scheduled transmissions once the power for non-scheduled transmissions has been taken into account, which is defined as follows:

P_{remaining,s}=max(PMax−ΣᵢP_{DPCCH,target,i}−P_{HS-DPCCH}−P_{non-SG},0). Equation (4)

In a case where a WTRU has more than one activated uplink frequency and one retransmission is required in one activated uplink frequency, the WTRU may estimate the NRPM available for E-TFC selection using the power allocated to the activated uplink frequency for which a retransmission is required (P_{allocated,x}) and the power allocated to the activated uplink frequency for which no retransmission is required (P_{allocated,y}), which are defined as follows:

P_{allocated,y}=PMax−P_{HS-DPCCH}−ΣᵢP_{DPCCH,target,i}−P_{E-DPCCH,x}−P_{E-DPDCH,x}, Equation (5)

P_{allocated,x}=P_{E-DPCCH,x}+P_{E-DPDCH,x}, Equation (6)

where PMax represents the maximum WTRU transmitter power. P_{E-DPDCH,x} represents the estimated E-DPDCH transmit power for the uplink frequency for which a retransmission is required. The estimate is based on P_{DPCCH,target,x} where x denotes the index of the activated uplink frequency on which a retransmission required and the E-DPDCH gain factor which will be used for the retransmission. P_{E-DPCCH,x} represents the estimated E-DPCCH transmit power for the uplink frequency for which a retransmission is required. The estimate is based on P_{DPCCH,target,x} where x denotes the index of the activated uplink frequency on which a retransmission is required and the E-DPCCH gain factor which will be used for the retransmission.

For both cases above, P_{HS-DPCCH} represents the estimated HS-DPCCH transmit power and may be calculated based on the estimated primary activated frequency DPCCH power, and the greatest of (Δ_{ACK}+1), (Δ_{NACK}+1) and (ΔCQI+1) where Δ_{ACK}, Δ_{NACK} and Δ_{CQI} are the most recent signaled values.

NRPMⱼ or NRPM_{i,j} may be determined by the maximum power minus the power of the HS-DPCCH and other channels other than the E-DPDCH. In 3GPP releases up to R10 4C-HSDPA, it was specified to only take into account one HS-DPCCH because there is at most one HS-DPCCH on each radio link if Secondary_Cell_Enabled is less than 4 (i.e., no more than 4 downlink carriers are configured).

However, in MC-HSDPA with more than 4 downlink carriers configured (i.e., Secondary_Cell_Enabled>3), there may be more than one HS-DPCCH on each radio link. For example, in 8C-HSDPA, two HS-DPCCHs with SF of 128 may be configured. Due to the introduction of more than one HS-DPCCH in MC-HSDPA with M>4 (i.e., Secondary_Cell_Enabled>3), E-TFC restriction procedure needs to be re-defined to accommodate the total power of multiple HS-DPCCHs. It should be noted that although the embodiments below are described in the context of 8C-HSDPA or MC-HSDPA, it may be applicable to other systems where one or more HS-DPCCHs may be used.

If more than one (K) HS-DPCCH is configured in MC-HSDPA (the gain factors used for different HS-DPCCHs during the measurement period may be different or same), the WTRU transmit power estimation for a given TFC may be calculated differently for the following cases: one case where one HS-DPCCH is transmitted either partially or totally within the given measurement period, and the other case where more than one HS-DPCCHs are transmitted either partially or totally within the given measurement period.

If one HS-DPCCH is transmitted either partially or totally within the given measurement period, the WTRU transmit power estimation for a given TFC may be calculated based on DPDCH and DPCCH gain factors, the maximum value of the transmitted HS-DPCCH gain factor that is used during the measurement period, and the reference transmit power.

If more than one HS-DPCCH is transmitted either partially or totally within the given measurement period, the WTRU transmit power estimation for a given TFC may be calculated based on DPDCH and DPCCH gain factors, the reference transmit power, and a combined HS-DPCCH transmit power that is used during the measurement period. The combined HS-DPCCH transmit power may be calculated by one or any combination of the following methods.

In one embodiment, the WTRU may first individually (or independently) calculate each HS-DPCCH transmit power as defined above for the case that one HS-DPCCH is transmitted either partially or totally within the given measurement period. The WTRU then, based on all the estimated HS-DPCCH transmit power, calculate the combined HS-DPCCH transmit power by as a sum of all individually estimated HS-DPCCH transmit power, as a maximum of all individually estimated HS-DPCCH transmit power, as 2 (or any other number) times of the maximum of all individually estimated HS-DPCCH transmit power, as 2 (or any other number) times of the minimum of all individually estimated HS-DPCCH transmit power, or the like.

In another embodiment, the WTRU may first select a common gain factor for calculating the combined HS-DPCCH transmit power, and then calculate the combined transmit power for all K HS-DPCCHs by summing K (or K times) estimated HS-DPCCH transmit power calculated based on the common gain factor and reference power. The common gain factor may be selected based on a certain criteria such as the maximum of all HS-DPCCH gain factors that are used during the measurement period, the average of all HS-DPCCH gain factors that are used during the measurement period, the maximum or average of the primary HS-DPCCH (i.e., HS-DPCCH on which serving HS-DSCH cell is mapped) gain factor that is used during the measurement period, or the maximum or average of the pre-defined or specified secondary HS-DPCCH (i.e., HS-DPCCHₖ on which secondary serving HS-DSCH cell is mapped) gain factor that is used during the measurement period.

In an 8C-HSDPA case where two HS-DPCCHs with SF of 128 are configured, the WTRU transmit power estimation for a given TFC may be calculated as follows. If one HS-DPCCH is transmitted either partially or totally within the given measurement period, the WTRU transmit power estimation for a given TFC may be calculated using DPDCH and DPCCH gain factors, the maximum value of the HS-DPCCH gain factor that is used during the measurement period, and the reference transmit power. The timing of the measurement period is same as the timing of the DPCH slot. If two HS-DPCCHs are transmitted either partially or totally within the given measurement period, the WTRU transmit power estimation for a given TFC may be calculated using DPDCH and DPCCH gain factors, the maximum value of each HS-DPCCH (i.e., HS-DPCCH and HS-DPCCH2) gain factor that is used during the measurement period, and the reference transmit power, in one or any combination of the methods described above. The timing of the measurement period is same as the timing of the DPCH slot.

Alternatively, if one or two HS-DPCCHs are transmitted either partially or totally within the given measurement period, the WTRU transmit power estimation for a given TFC may be calculated using DPDCH and DPCCH gain factors, the maximum value of the HS-DPCCH gain factor (or the maximum values of each HS-DPCCH gain factors if two HS-DPCCHs are configured and transmitted) that is used during the measurement period, and the reference transmit power. The timing of the measurement period is same as the timing of the DPCH slot. The combined HS-DPCCH transmit power may be implemented in one or any combination of the methods described above.

In order to calculate NRPM available for the E-TFC selection, when more than one HS-DPCCH is used in MC-HSDPA with M>4 or 8C-HSDPA, an E-TFC restriction procedure may be implemented by one or any combination of the following methods.

In a first method, instead of changing the above Equations (Equations (1), (4), and (5)) used in E-TFC restriction procedure, P_{HS-DPCCH} may be defined as the total estimated HS-DPCCH transmit power, determined as the sum of the estimated HS-DPCCH transmit power for each configured and transmitted HS-DPCCH (e.g., HS-DPCCH1 and/or HS-DPCCH2). The estimated HS-DPCCH transmit power for each HS-DPCCH may be calculated based on the maximum HS-DPCCH gain factor for corresponding HS-DPCCH based on P_{DPCCH,target} and the most recent signaled values of Δ_{ACK}, Δ_{NACK} and Δ_{CQI}.

A first example implementation for MC-HSDPA or 8C-HSDPA is described below.

When a WTRU has one activated uplink frequency, P_{HS-DPCCH}=estimated HS-DPCCH transmit power based on the maximum HS-DPCCH gain factor based on P DPCCH,target and the most recent signaled values of Δ_{ACK}, Δ_{NACK} and Δ_{CQI}. If two HS-DPCCHs are transmitted, P_{HS-DPCCH} is the estimated total HS-DPCCH transmit power over both HS-DPCCHᵢ and HS-DPCCH₂. If the target E-DCH TTI for which NRPMⱼ is evaluated corresponds to a compressed mode frame then the modification to the gain factors which occur due to compressed mode may be included in the estimate of P_{HS-DPCCH}.

If the WTRU is configured in MIMO without DC-HSDPA mode, then the estimated HS-DPCCH transmit power may be based on P DPCCH,target and the greatest of (Δ_{ACK}+1), (Δ_{NACL}+1) and (Δ_{CQI}+1) when CQI of type A is to be transmitted, and the greatest of (Δ_{ACK}+1), (Δ_{NACK}+1) and Δ_{CQI} when CQI of type B is to be transmitted, where Δ_{ACK}, Δ_{NACK} and Δ_{CQI} are the most recent signaled values.

If the WTRU is configured in DC-HSDPA or DC-HSDPA-MIMO, then the estimated HS-DPCCH transmit power may be based on P DPCCH,target and the greatest of (Δ_{ACK}+1), (Δ_{NACK}+1) and (Δ_{CQI}+1) where Δ_{ACK}, Δ_{NACK} and Δ_{CQI} are the most recent signaled values.

If the WTRU is configured in 3C/4C-HSDPA (Secondary_Cell_Enabled >1), then the estimated HS-DPCCH transmit power may be based on P DPCCH,target and the greatest of (Δ_{ACK}+2), (Δ_{NACK}+2), and (Δ_{CQI}+2), where Δ_{ACK}, Δ_{NACK} and Δ_{CQI} are the most recent signaled values.

If the WTRU is configured in 8C-HSDPA (i.e., Secondary_Cell_Enabled >3), then the estimated HS-DPCCH transmit power for each transmitted HS-DPCCH may be based on P_{DPCCH,target} and the greatest of (Δ_{ACK}+2), (Δ_{NACK}+2), and (Δ_{CQI}+2), where Δ_{ACK}, Δ_{NACK} and Δ_{CQI} are the most recent signaled values.

When the WTRU has more than one activated uplink frequency, P_{HS-DPCCH} represents the estimated HS-DPCCH transmit power and may be calculated based on the estimated primary activated frequency DPCCH power, and the greatest of (Δ_{ACK}+1), (Δ_{NACK}+1) and (Δ_{CQI}+1) if Secondary_Cell_Enabled<2 (or the greatest of (Δ_{ACK}+2), (Δ_{NACK}+2) and (Δ_{CQI}+2) otherwise) where Δ_{ACK}, Δ_{NACK} and Δ_{CQI} are the most recent signaled values.

As an alternative to the first example implementation, 3C/4C-HSDPA and 8C-HSDPA cases may be combined together as they use the same maximum power offset to protect the worst cases while maintaining the existing definition in case of Secondary_Cell_Enabled<2 as follows.

When a WTRU has one activated uplink frequency, if Secondary_Cell_Enabled>1, then the estimated HS-DPCCH transmit power for each transmitted HS-DPCCH may be based on P_{DPCCH,target} and the greatest of (Δ_{ACK}+2), (Δ_{NACK}+2), and (Δ_{CQI}+2), where Δ_{ACK}, Δ_{NACK} and Δ_{CQI} are the most recent signaled values.

When the WTRU has more than one activated uplink frequency, P_{HS}-DPCCH represents the estimated HS-DPCCH transmit power and may be calculated based on the estimated primary activated frequency DPCCH power, and the greatest of (Δ_{ACK}+1), (Δ_{NACK}+1) and (Δ_{CQI}+1) if Secondary_Cell_Enabled<4 (or the greatest of (Δ_{ACK}+2), (Δ_{NACK}+2) and (Δ_{CQI}+2) otherwise), where Δ_{ACK}, Δ_{NACK} and Δ_{CQI} are the most recent signaled values.

As another alternative to the first example implementation, 3C-HSDPA without MIMO configuration may be distinguished from the cases of 3C-HSDPA with MIMO and 4C-HSDPA as they may use a different maximum power offset when maintaining other cases as follows.

When a WTRU has one activated uplink frequency, if the WTRU is configured in 3C-HSDPA (i.e., Secondary_Cell_Enabled=2) without MIMO, then the estimated HS-DPCCH transmit power may be based on P_{DPCCH,target} and the greatest of (Δ_{ACK}+1), (Δ_{NACK}+1), and (Δ_{CQI}+1), where Δ_{ACK}, Δ_{NACK}, and Δ_{CQI} are the most recent signaled values.

If the WTRU is configured in 3C-HSDPA (Secondary_Cell_Enabled=2) with MIMO or 4C-HSDPA (i.e., Secondary_Cell_Enabled=3), then the estimated HS-DPCCH transmit power may be based on P_{DPCCH,target} and the greatest of (Δ_{ACK}+2), (Δ_{NACK}+2), and (Δ_{CQI}+2), where Δ_{ACK}, Δ_{NACK}, and A_{M} are the most recent signaled values.

When the WTRU has more than one activated uplink frequency, P_{HS}-DPCCH represents the estimated HS-DPCCH transmit power and may be calculated based on the estimated primary activated frequency DPCCH power, and the greatest of (Δ_{ACK}+1), (Δ_{NACK}+1), and (Δ_{CQI}+1) if Secondary_Cell_Enabled<2 (or the greatest of (A_{ACK}+1), (Δ_{NACK}+1), and (Δ_{CQI}+1) if Secondary_Cell_Enabled=3 with MIMO configured, or the greatest of (A_{ACK}+2), (Δ_{NACK}+2), and (Δ_{CQI}+2) otherwise), where Δ_{ACK}, Δ_{NACK} and Δ_{CQI} are the most recent signaled values.

In a second method, when more than one (assuming K>1) HS-DPCCH is configured and transmitted in MC-HSDPA with M>4 or 8C-HSDPA (i.e., Secondary_Cell_Enabled>3), a new item−ΣₖP_{HS-DPCCHk} may be added to the above equations to account for the sum of estimated HS-DPCCHₖ transmit power for additional HS-DPCCHs besides the primary HS-DPCCH (i.e., legacy HS-DPCCH) as follows:

NRPMⱼ=(PMaxⱼ−P_{DPCCH,target}−P_{DPDCH}−P_{HS-DPCCH}−ΣₖP_{HS-DPCCHk}−P_{E-DPCCH,j})/P_{DPCCH,target}, Equation (7)

P_{remaining,s}=max(PMax−ΣᵢPDPCCH,target,i−P_{HS-DPCCH}−ΣₖP_{HS-DPCCHk}−P_{non-SG},0), Equation (8)

P_{allocated,y}=PMax−P_{HS-DPCCH}−ΣₖP_{HS-DPCCHk}−ΣᵢP_{DPCCH,target,i}−P_{E-DPCCH,x}−P_{E-DPDCH,x,} Equation (9)

where P_{HS-DPCCHk} represents the estimated HS-DPCCH transmit power with index k (k=2, 3, . . . K) and is calculated based on the maximum HS-DPCCH gain factor for corresponding HS-DPCCHₖ based on P_{DPCCH,target} and the most recent signaled values of Δ_{ACK}, Δ_{NACK} and Δ_{CQI} in the same manner as P_{HS-DPCCH}.

One example implementation of the second method in case of 8C-HSDPA (or when Secondary_Cell_Enabled>3) where two HS-DPCCHs with SF of 128 are used is described below. When a WTRU has one activated uplink frequency, NRPM may be defined as follows:

NRPMⱼ=(PMaxⱼ−P_{DPCCH,target}−P_{DPDCH}−P_{HS-DPCCH}−P_{HS-DPCCH2}−P_{E-DPCCH,j})/P_{DPCCH,target}, Equation (10)

where P_{HS-DPCCH} is defined as above when Secondary_Cell_Enabled<4.

P_{HS-DPCCH}2 is an estimated HS-DPCCH2 transmit power based on the maximum HS-DPCCH2 gain factor based on P_{DPCCH,target} and the greatest of (A_{ACK}+2), (Δ_{NACK}+2), and (Δ_{CQI}+2), where Δ_{ACK}, Δ_{NACK} and Δ_{CQI} are the most recent signaled values. If the target E-DCH TTI for which NRPMⱼ is evaluated corresponds to a CM frame then the modification to the gain factors due to CM may be included in the estimate of P_{HS-DPCCH}2.

When the WTRU has more than one activated uplink frequency, the WTRU may estimate the NRPM available for E-TFC selection for the i-th activated uplink frequency (where i (=1 or 2) corresponds to the index of the primary uplink frequency and the index of the secondary uplink frequency) based on the following equation for E-TFC candidate j:

NRPM_{i,j}=(P_{allocated,i}−P_{E-DPCCHi,j})/P_{DPCCH,target,i} Equation (11)

where P_{allocated, i} indicates the power allocated to the i-th uplink frequency by the WTRU based on the following cases.

In a case where a WTRU has more than one activated uplink frequency and no retransmission is required, or where a WTRU has more than one activated uplink frequency and two retransmissions are required,

P_{allocated,1}=P₁+P_{non-SG}, Equation (12)

P_{allocated,2}=P₂, Equation (13)

where Pᵢ represents the maximum remaining allowed power for scheduled transmissions for the i-th activated uplink frequency defined as follows:

$${P}_{i} = {P}_{remaining , s} \frac{{P}_{DPCCH , target , i} {SG}_{i}}{{\sum }_{k} {P}_{DPCCH , target , k} {SG}_{k}} \qquad Equation ( 14 )$$

where P_{remaining,s} is the remaining power for scheduled transmissions once the power for non-scheduled transmissions has been taken into account, defined as follows:

P_{remaining,s}=max(PMax−ΣᵢP_{DPCCH,target,i}−P_{HS-DPCCH}−P_{HS-DPCCH2}−P_{non-SG},0). Equation (15)

In a case where a WTRU has more than one activated uplink frequency and one retransmission is required in one activated uplink frequency, the WTRU may estimate the NRPM available for E-TFC selection using the power allocated to the activated uplink frequency for which a retransmission is required (P_{allocated,x}) and the power allocated to the activated uplink frequency for which no retransmission is required (P_{allocated,y}), which are defined as follows:

P_{allocated,y}=PMax−P_{HS-DPCCH}−P_{HS-DPCCH2}−ΣᵢP_{DPCCH,target,i}−P_{E-DPCCH,x}−P_{E-DPDCH,x}, Equation (16)

P_{allocated,x}=P_{E-DPCCH,x}+P_{E-DPDCH,x}. Equation (17)

For both cases above, P_{HS-DPCCH} is defined as above when Secondary_Cell_Enabled<4. P_{HS-DPCCH2} represents the estimated HS-DPCCH2 transmit power and may be calculated based on the estimated primary activated frequency DPCCH power, and the greatest of (Δ_{ACK}+2), (Δ_{NACK}+2) and (Δ_{CQI}+2), where Δ_{ACK}, Δ_{NACK} and Δ_{CQI} are the most recent signaled values.

As an alternative to the second method, the second method may be changed to include an estimated HS-DPCCH transmit power into the new item −ΣₖPHS-DPCCHk with index k (k=0, 2, 3, . . . , K). More specifically, when more than one (assuming K>1) HS-DPCCH is configured and transmitted in MC-HSDPA with M>4 or 8C-HSDPA, the NRPM-related equations may be defined to account for the sum of estimated HS-DPCCHₖ transmit power for all HS-DPCCHs including the primary HS-DPCCH (i.e., legacy HS-DPCCH) as follows.

When a WTRU has one activated uplink frequency, NRPM may be calculated as follows:

NRPMⱼ=(PMaxⱼ−P_{DPCCH,target}−P_{DPDCH}−ΣₖP_{HS-DPCCHk}−P_{E-DPCCH,j})/P_{DPCCH,target}, Equation (18)

When a WTRU has more than one activated uplink frequency, the equations may be amended as follows:

P_{remaining,s}=max(PMax−ΣᵢP_{DPCCH,target,i}−ΣₖP_{HS-DPCCHk}−P_{non-SG},0), Equation (19)

P_{allocated,y}=PMax−ΣₖP_{HS-DPCCHk}−ΣᵢP_{DPCCH,target,i}−P_{E-DPCCH,x}−P_{E-DPDCH,x} Equation (20)

where P_{HS-DPCCHk} represents the estimated HS-DPCCH transmit power with index k (k=0, 2, 3, . . . K) and is calculated based on the maximum HS-DPCCH gain factor for corresponding HS-DPCCHₖ based on P_{DPCCH,target} and the most recent signalled values of Δ_{ACK}, Δ_{NACK} and Δ_{CQI}.

Alternatively, E-TFC restriction may defined the estimated HS-DPCCH transmit based on secondary serving HS-DSCH cells' activation status which may be used for both methods above based on RRC configuration.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method for sending feedback for multi-cell high speed downlink packet access (HSDPA) operations, the method comprising:
receiving downlink transmissions from a plurality of cells;
generating hybrid automatic repeat request acknowledgement (HARQ-ACK) messages and/or channel quality indication (CQI) or precoding control indication/channel quality indication (PCI/CQI) messages for the cells;
encoding the HARQ-ACK messages and/or the CQI or PCI/CQI messages; and
sending the encoded HARQ-ACK messages and/or the encoded CQI or PCI/CQI messages on a plurality of high speed dedicated physical control channels (HS-DPCCHs) with a spreading factor of 128,
wherein each HS-DPCCH is configured to carry at least two encoded HARQ-ACK messages and at least two encoded CQI or PCI/CQI messages in an HS-DPCCH subframe,
wherein each HARQ-ACK message is mapped to two cells so that HARQ information for two cells are jointly encoded, and each CQI or PCI/CQI message is mapped to one cell, and the encoded CQI or PCI/CQI messages of up to four cells are transmitted in a first report and the encoded CQI or PCI/CQI messages of up to another four cells are transmitted in a second report over two HS-DPCCH subframes,
wherein the cells are re-mapped to an HARQ-ACK message and a CQI or PCI/CQI message and/or the HARQ-ACK message and/or the CQI or PCI/CQI message are repeated within an HS-DPCCH on a condition that any cell is activated or deactivated on that HS-DPCCH.

2. The method of claim 1 wherein in case three cells are active on any one of the HS-DPCCHs, HARQ-ACK information of two active cells are jointly encoded and HARQ-ACK information of the other active cell is jointly encoded with discontinuous transmission (DTX) message.

3. The method of claim 1 wherein in case two cells are active on any one of the HS-DPCCHs, HARQ-ACK information of two active cells are jointly encoded and a resulting codeword is repeated to fill in an HARQ-ACK slot of the HS-DPCCH.

4. The method of claim 1 wherein in case one cell is active on any one of the HS-DPCCHs, HARQ-ACK information of the active cell is encoded with a discontinuous transmission (DTX) message and a resulting codeword is repeated to fill in an HARQ-ACK slot of the HS-DPCCH.

5. The method of claim 1 wherein in case no cell is active on any one of the HS-DPCCHs, an HARQ-ACK slot of the HS-DPCCH is not transmitted or a discontinuous transmission (DTX) codeword is repeated to fill in the HARQ-ACK slot of the HS-DPCCH.

6. The method of claim 1 wherein in case three cells are active on any one of the HS-DPCCHs, CQI or PCI/CQI messages of two active cells are carried in the first report, and a CQI or PCI/CQI message of the other active cell is repeated in the second report.

7. The method of claim 1 wherein in case two cells are active on any one of the HS-DPCCHs, a CQI or PCI/CQI message of one cell is repeated in the first report, and a CQI or PCI/CQI message of the other cell is repeated in the second report.

8. The method of claim 1 wherein in case one cell is active on any one of the HS-DPCCHs, a CQI or PCI/CQI message of the active cell is repeated in the first report and the second report is not transmitted.

9. The method of claim 1 wherein in case no cell is active on an HS-DPCCH, CQI or PCI/CQI slots of the HS-DPCCH is not transmitted.

10. The method of claim 1 wherein a power offset for the HARQ-ACK message or the CQI or PCI/CQI message on each HS-DPCCH is determined independently based on a number of active secondary cells and multiple-input multiple-output (MIMO) configuration status on corresponding HS-DPCCH.

11. The method of claim 1 further comprising:
transmitting an HARQ preamble and a postamble simultaneously on both HS-DPCCHs on a condition that a condition for transmitting the HARQ preamble and HARQ postamble is satisfied on both HS-DPCCHs.

12. A wireless transmit/receive unit (WTRU) for sending feedback for multi-cell high speed downlink packet access (HSDPA) operations, the WTRU comprising:
a transceiver configured to receive downlink transmissions from a plurality of cells; and
a processor configured to generate hybrid automatic repeat request acknowledgement (HARQ-ACK) messages and/or channel quality indication (CQI) or precoding control indication/channel quality indication (PCI/CQI) messages for the cells, encode the HARQ-ACK messages and/or the CQI or PCI/CQI messages, and send the encoded HARQ-ACK messages and/or the encoded CQI or PCI/CQI messages on a plurality of high speed dedicated physical control channels (HS-DPCCHs) with a spreading factor of 128,
wherein each HS-DPCCH is configured to carry at least two encoded HARQ-ACK messages and at least two encoded CQI or PCI/CQI messages in an HS-DPCCH subframe,
wherein each HARQ-ACK message is mapped to two cells so that HARQ information for two cells are jointly encoded, and each CQI or PCI/CQI message is mapped to one cell, and the encoded CQI or PCI/CQI messages of up to four cells are transmitted in a first report and the encoded CQI or PCI/CQI messages of up to another four cells are transmitted in a second report over two HS-DPCCH subframes,
wherein the processor is configured to remap the cells to an HARQ-ACK message and a CQI or PCI/CQI message and/or the HARQ-ACK message and/or the CQI or PCI/CQI message is repeated within an HS-DPCCH on a condition that any cell is activated or deactivated on that HS-DPCCH.

13. The WTRU of claim 12 wherein in case three cells are active on any one of the HS-DPCCHs, the processor is configured to jointly encode HARQ-ACK information of two active cells and jointly encode HARQ-ACK information of the other active cell with discontinuous transmission (DTX) message.

14. The WTRU of claim 12 wherein in case two cells are active on any one of the HS-DPCCHs, the processor is configured to jointly encode HARQ-ACK information of two active cells and repeat a resulting codeword to fill in an HARQ-ACK slot of the HS-DPCCH.

15. The WTRU of claim 12 wherein in case one cell is active on any one of the HS-DPCCHs, the processor is configured to encode HARQ-ACK information of the active cell with discontinuous transmission (DTX) message and repeat a resulting codeword to fill in an HARQ-ACK slot of the HS-DPCCH.

16. The WTRU of claim 12 wherein in case no cell is active on any one of the HS-DPCCHs, the processor is configured to not transmit an HARQ-ACK slot of the HS-DPCCH or repeat a discontinuous transmission (DTX) codeword to fill in the HARQ-ACK slot of the HS-DPCCH.

17. The WTRU of claim 12 wherein in case three cells are active on any one of the HS-DPCCHs, the processor is configured to transmit CQI or PCI/CQI messages of two active cells in the first report, and repeat a CQI or PCI/CQI message of the other active cell in the second report.

18. The WTRU of claim 12 wherein in case two cells are active on any one of the HS-DPCCHs, the processor is configured to repeat a CQI or PCI/CQI message of one cell in the first report and repeat a CQI or PCI/CQI message of the other cell in the second report.

19. The WTRU of claim 12 wherein in case one cell is active on any one of the HS-DPCCHs, the processor is configured to repeat a CQI or PCI/CQI message of the active cell in the first report, and not transmit the second report.

20. The WTRU of claim 12 wherein in case no cell is active on any one of the HS-DPCCHs, the processor is configured to not transmit a CQI or PCI/CQI slots of the HS-DPCCH.

21. The WTRU of claim 12 wherein a power offset for the HARQ-ACK message or the CQI or PCI/CQI message on each HS-DPCCH is determined independently based on a number of active secondary cells and multiple-input multiple-output (MIMO) configuration status on corresponding HS-DPCCH.

22. The WTRU of claim 12 wherein the processor is configured to send an HARQ preamble and a postamble simultaneously on both HS-DPCCHs on a condition that a condition for transmitting the HARQ preamble and HARQ postamble is satisfied on both HS-DPCCHs.
